(19) United States
(12) Patent Application Publication
(10) Pub. No.: US 2024/0199773 A1
(43) Pub. Date: Jun. 20, 2024

(54) COMPOSITION AND METHOD FOR PRODUCING COMPOSITION

(71) Applicant: KANEKA CORPORATION, Osaka (JP)

(72) Inventor: Nobuyoshi Maizuru, Hyogo (JP)

(73) Assignee: KANEKA CORPORATION, Osaka (JP)

(21) Appl. No.: 18/591,887

(22) Filed: Feb. 29, 2024

Related U.S. Application Data
(63) Continuation of application No. PCT/JP2022/030280, filed on Aug. 8, 2022.

(30) Foreign Application Priority Data
Sep. 1, 2021 (JP) 2021-142456

(51) Int. Cl. C08F 120/14; C08K 5/10

(52) U.S. Cl. CPC C08F 120/14; C08K 5/10

(57) ABSTRACT

A composition having excellent storage stability is provided. The composition contains a specific amount of fine polymer particles (A), a specific amount of a low molecular weight compound (B), and a radical scavenger (C) of hindered phenol base. The fine polymer particles (A) include an elastic body and a graft part. The elastic body contains at least one selected from diene-based rubbers, (meth)acrylate-based rubbers, and organosiloxane-based rubbers.

### TECHNICAL FIELD

One or more embodiments of the present invention relate to a composition, and a method for producing the composition.

### BACKGROUND

Radical-curing type curable resins such as unsaturated polyester-based resins and vinyl ester resins are widely used in various applications which are, for example, molding compositions each containing a reinforcement material (such as glass fibers) and a coating material.

These curable resins involve considerable cure shrinkage at the time of curing and cause a crack in a cured product due to an internal stress in the cured product. Under the circumstances, attempts to impart toughness to these curable resins, which are very fragile materials, have been studied in various ways.

For example, for an improvement in toughness of a curable resin, a method involving adding an elastomer to the curable resin is widely used. Examples of the elastomer encompass fine polymer particles (e.g., fine crosslinked polymer particles).

A method of adding, to a resin composition, a low molecular weight compound that has, in its molecule, at least one polymerizable unsaturated bond is known to reduce a viscosity of the resin composition containing a curable resin which has not been cured and to improve handleability.

For example, Patent Literature 1 discloses a resin composition containing a vinyl ester resin (matrix resin), a vinyl monomer (a low molecular weight compound that has, in its molecule, at least one polymerizable unsaturated bond), and fine polymer particles, in which the fine polymer particles are dispersed in the form of primary particles in the resin composition.

Patent Literatures 2 through 7 disclose a resin composition containing a matrix resin, fine polymer particles, and a hindered phenol-based antioxidant or the like as an additive to prevent polymer degradation.

### PATENT LITERATURE

### [Patent Literature 1]

International Publication No. WO 2010/143366

### [Patent Literature 2]

Japanese Patent Application Publication No. 2005-002345

### [Patent Literature 3]

Japanese Patent Application Publication No. 2009-545656

### [Patent Literature 4]

International Publication No. WO 2021/060482

### [Patent Literature 5]

Japanese Patent Application Publication No. 2019-019236

### [Patent Literature 6]

International Publication No. WO 2016/136726

### [Patent Literature 7]

Japanese Patent Application Publication No. 2001-123052

However, the conventional technique as described above is not sufficient in terms of storage stability, and has room for further improvements.

### SUMMARY

An aspect of one or more embodiments of the present invention has been made in view of the above, and provides a composition having excellent storage stability.

The inventor of one or more embodiments of the present invention has carried out diligent study, and consequently completed one or more embodiments of the present invention.

In other words, one or more embodiments of the present invention include the following features.

A composition containing: fine polymer particles (A); a low molecular weight compound (B) that has, in its molecule, at least one polymerizable unsaturated bond and has a molecular weight of less than 1,000; and a radical scavenger (C) of hindered phenol base, the fine polymer particles (A) containing a rubber-containing graft copolymer that includes an elastic body and a graft part grafted to the elastic body, the elastic body containing at least one selected from the group consisting of diene-based rubbers, (meth)acrylate-based rubbers, and organosiloxane-based rubbers, and an amount of the fine polymer particles (A) being 1% by weight to 50% by weight and an amount of the low molecular weight compound (B) being 50% by weight to 99% by weight, where 100% by weight represents a total amount of the fine polymer particles (A) and the low molecular weight compound (B).

A method for producing a composition, the method including: a first step of mixing an aqueous latex containing fine polymer particles (A) with an organic solvent that exhibits partial solubility in water, and then bringing a resulting mixture into contact with water to generate, in an aqueous phase, an agglutinate of the fine polymer particles (A), the agglutinate containing the organic solvent; a second step of separating and collecting the agglutinate from the aqueous phase, and then mixing the agglutinate with the organic solvent to obtain a first organic solvent dispersion slurry containing the fine polymer particles (A); a third step of mixing the first organic solvent dispersion slurry, a low molecular weight compound (B) that has, in its molecule, at least one polymerizable unsaturated bond and that has a molecular weight of less than 1,000, and a radical scavenger (C) of hindered phenol base to obtain a second organic solvent dispersion slurry containing the fine polymer particles (A), the low molecular weight compound (B), and the radical scavenger (C); and a fourth step of distilling off the organic solvent from the second organic solvent dispersion slurry, the first step, the second step, the third step, and the fourth step being carried out in this order, the fine polymer particles (A) containing a rubber-containing graft copolymer that includes an elastic body and a graft part grafted to the elastic body, the elastic body containing at least one selected from the group consisting of diene-based rubbers, (meth)acrylate-based rubbers, and organosiloxane-based rubbers, and in the third step, the fine polymer particles (A) and the low molecular weight compound (B) being mixed at a blending ratio in which an amount of the fine polymer particles (A) is 1% by weight to 50% by weight and an amount of the low molecular weight compound (B) is 50% by weight to 99% by weight, where 100% by weight represents a total amount of the fine polymer particles (A) and the low molecular weight compound (B).

An aspect of one or more embodiments of the present invention has the effect of making it possible to provide a composition having excellent storage stability.

### DETAILED DESCRIPTION

The following description will discuss one or more embodiments of the present invention. One or more embodiments of the present invention are not, however, limited to these embodiments. One or more embodiments of the present invention are not limited to the configurations described below, but may be altered in various ways within the scope of the claims. One or more embodiments of the present invention also encompass, in their technical scope, any embodiments or Examples derived by appropriately combining technical means disclosed in differing embodiments and Examples. Further, it is possible to form a new technical feature by combining the technical means disclosed in the respective embodiments. All academic and patent literatures cited in the present disclosure are incorporated herein by reference. Any numerical range expressed as “A to B” herein is intended to mean “not less than A and not more than B (i.e., a range from A to B which includes both A and B)” unless otherwise stated.

### 1. Technical Idea of One or More Embodiments of the Present Invention

The inventor of one or more embodiments of the present invention has studied a method of preparing a composition containing fine polymer particles and a low molecular weight compound, and adding the composition to a curable resin which has not been cured, in order to obtain a resin composition containing (a) the curable resin which has not been cured, (b) the fine polymer particles, and (c) the low molecular weight compound that has, in its molecule, at least one polymerizable unsaturated bond.

In the course of the diligent study, the inventor of one or more embodiments of the present invention has uniquely found that a composition (hereinafter sometimes referred to simply as a “composition”) containing fine polymer particles and a low molecular weight compound that has, in its molecule, at least one polymerizable unsaturated bond tends to be easily gelatinized during storage, that is, there is a problem in terms of storage stability, as compared to a case where only a low molecular weight compound that has, in its molecule, at least one polymerizable unsaturated bond is stored. The inventor of one or more embodiments of the present invention has carried out further study with the aim of providing a composition which contains fine polymer particles and a low molecular weight compound that has, in its molecule, at least one polymerizable unsaturated bond and which has excellent storage stability. That is, one or more embodiments of the present invention provide a composition which contains fine polymer particles and a low molecular weight compound that has, in its molecule, at least one polymerizable unsaturated bond and which has excellent storage stability.

In the course of the further study, the inventor of one or more embodiments of the present invention has made the following findings: by adding 4-hydroxy-2,2,6,6-tetramethylpiperidine-1-oxyl (H-TEMPO), which is a general radical scavenger, to a composition containing fine polymer particles and a low molecular weight compound that has, in its molecule, at least one polymerizable unsaturated bond, it is possible, surprisingly, to inhibit gelation during storage of the composition. It is not clear why the addition of H-TEMPO inhibited gelation of the composition during storage. The inventor of one or more embodiments of the present invention has inferred the reason as in the following (i) and (ii): (i) in the composition, polymerization of the low molecular weight compound occurs by a radical generated in the composition during storage, and an increase in molecular weight proceeds and thus the composition is gelatinized; and (ii) by adding H-TEMPO, which is a radical scavenger, to the composition, polymerization of the low molecular weight compound is hindered, and consequently gelation of the composition can be inhibited.

However, the composition to which H-TEMPO has been added makes the composition highly viscous during storage, although gelation during storage of the composition can be inhibited. That is, the inventor of one or more embodiments of the present invention has uniquely found that there is room for further improvements in storage stability of the composition. In this context, the inventor of one or more embodiments of the present invention has carried out, on the basis of the above novel findings, further study for seeking a radical scavenger which can further improve storage stability of the composition. As a result, the inventor of one or more embodiments of the present invention has made a novel finding that a radical scavenger of hindered phenol base can not only inhibit gelation during storage of the composition, but also inhibit an increase in viscosity during storage of the composition, that is, the radical scavenger of hindered phenol base can further improve storage stability of the composition. In other words, the inventor of one or more embodiments of the present invention has uniquely made the following findings and attained one or more embodiments of the present invention: by allowing coexistence of a radical scavenger of hindered phenol base in a composition containing fine polymer particles and a low molecular weight compound that has, in its molecule, at least one polymer unsaturated bond, it is possible to obtain a composition that has excellent storage stability without fear of gelation and increase in viscosity during storage.

### 2. Composition

A composition in accordance with one or more embodiments of the present invention contains fine polymer particles (A), a low molecular weight compound (B) that has, in its molecule, at least one polymerizable unsaturated bond and has a molecular weight of less than 1,000, and a radical scavenger (C) of hindered phenol base. The fine polymer particles (A) contain a rubber-containing graft copolymer that includes an elastic body and a graft part grafted to the elastic body. The elastic body of the fine polymer particles (A) contains at least one selected from the group consisting of diene-based rubbers, (meth)acrylate-based rubbers, and organosiloxane-based rubbers. An amount of the fine polymer particles (A) is 1% by weight to 50% by weight, and an amount of the low molecular weight compound (B) is 50% by weight to 99% by weight, where 100% by weight represents a total amount of the fine polymer particles (A) and the low molecular weight compound (B).

The composition in accordance with one or more embodiments of the present invention has excellent storage stability, because the composition has the above described configuration. More specifically, the composition in accordance with one or more embodiments of the present invention, by containing the radical scavenger (C), has an advantage of having extremely excellent storage stability as compared to a composition that does not contain the radical scavenger (C). Furthermore, the composition in accordance with one or more embodiments of the present invention contains a hindered phenol-based radical scavenger (C) as a radical scavenger. Therefore, the composition in accordance with one or more embodiments of the present invention has an advantage of having excellent storage stability as compared to a composition containing a radical scavenger that is not of hindered phenol base, such as H-TEMPO which is a general radical scavenger.

A “composition in accordance with one or more embodiments of the present invention” herein may be referred to simply as a “present composition”.

In the present disclosure, the storage stability of the composition can be evaluated based on the rate of change in viscosity and the presence or absence of gelation. Note, here, that the rate of change in viscosity is a ratio of a difference between a viscosity of the composition before storage (immediately after production) and a viscosity of the composition after storage. More specifically, the rate of change in viscosity is a value represented by the following expression (1).

Rate of change in viscosity (%)={(viscosity of composition after storage (V₁)−viscosity of composition before storage (V₀))/viscosity of composition before storage (V₀)}×100 (1)

The phrase “the composition has excellent storage stability” herein is intended to mean that a rate of change in viscosity of the composition which has been stored at 80° C. for 7 days is not more than 30%, and the composition is not gelatinized when the composition has been stored at 80° C. for 2 days. A rate of change in viscosity of the present composition exhibited when the present composition has been stored at 80° C. for 7 days may be not more than 27%, or not more than 25%.

In the present disclosure, the “polymerizable unsaturated bond” is intended to mean an unsaturated bond that has polymerizability. In other words, it can also be said that the polymerizable unsaturated bond is a bond that serves as an origin at which a polymerization reaction is initiated. In the present disclosure, it can be said that the “compound having, in its molecule, at least one polymerizable unsaturated bond” is a “monomer having at least one radical-polymerizable reactive group in the same molecule”. The “radical-polymerizable reactive group” is intended to mean a reactive group having radical polymerizability. In other words, it can also be said that the radical-polymerizable reactive group is a reactive group that, when the reactive group is attacked by a radical, serves as an origin at which a radical polymerization reaction is initiated.

### <2-1. Fine Polymer Particles (A)>

The fine polymer particles (A) contain a rubber-containing graft copolymer that includes an elastic body and a graft part grafted to the elastic body.

### (Elastic Body)

The elastic body contains at least one selected from the group consisting of diene-based rubbers, (meth)acrylate-based rubbers, and organosiloxane-based rubbers. The elastic body may contain natural rubber other than the above described rubber. The elastic body can also be referred to as elastic part(s) or rubber particle(s). In the present disclosure, (meth)acrylate means acrylate and/or methacrylate.

A case where the elastic body contains a diene-based rubber (case A) will be described below. In the case A, a resulting composition can provide a cured product which has excellent toughness and excellent impact resistance. It can be said that a cured product that has excellent toughness and/or excellent impact resistance is a cured product that has excellent durability.

The diene-based rubber is an elastic body containing, as a structural unit, a structural unit derived from a diene-based monomer. The diene-based monomer can also be referred to as a conjugated diene-based monomer. In the case A, among 100% by weight of structural units, (i) the diene-based rubber may contain 50% by weight to 100% by weight of a structural unit derived from a diene-based monomer, and 0% by weight to 50% by weight of a structural unit derived from a vinyl-based monomer that is not a diene-based monomer and that is copolymerizable with a diene-based monomer, (ii) the diene-based rubber may contain more than 50% by weight but not more than 100% by weight of a structural unit derived from a diene-based monomer and not less than 0% by weight but less than 50% by weight of a structural unit derived from a vinyl-based monomer that is not a diene-based monomer and that is copolymerizable with a diene-based monomer, (iii) the diene-based rubber may contain 60% by weight to 100% by weight of a structural unit derived from a diene-based monomer and 0% by weight to 40% by weight of a structural unit derived from a vinyl-based monomer that is not a diene-based monomer and that is copolymerizable with a diene-based monomer, (iv) the diene-based rubber may contain 70% by weight to 100% by weight of a structural unit derived from a diene-based monomer and 0% by weight to 30% by weight of a structural unit derived from a vinyl-based monomer that is not a diene-based monomer and that is copolymerizable with a diene-based monomer, (v) the diene-based rubber may contain 80% by weight to 100% by weight of a structural unit derived from a diene-based monomer and 0% by weight to 20% by weight of a structural unit derived from a vinyl-based monomer that is not a diene-based monomer and that is copolymerizable with a diene-based monomer, (vi) the diene-based rubber may contain 90% by weight to 100% by weight of a structural unit derived from a diene-based monomer and 0% by weight to 10% by weight of a structural unit derived from a vinyl-based monomer that is not a diene-based monomer and that is copolymerizable with a diene-based monomer, and (vii) the diene-based rubber may consist only of a structural unit derived from a diene-based monomer.

In the case A, the diene-based rubber may contain, as a structural unit, a structural unit derived from a (meth)acrylate-based monomer in an amount smaller than the amount of the structural unit derived from the diene-based monomer.

Examples of the diene-based monomer encompass 1,3-butadiene, isoprene (2-methyl-1,3-butadiene), and 2-chloro-1,3-butadiene. These diene-based monomers may be used alone or in combination of two or more.

Examples of the vinyl-based monomer (hereinafter also referred to as vinyl-based monomer A) which is different from the diene-based monomer and which is copolymerizable with the diene-based monomer encompass: vinyl arenes such as styrene, α-methylstyrene, monochlorostyrene, and dichlorostyrene; vinyl carboxylic acids such as acrylic acid and methacrylic acid; vinyl cyanides such as acrylonitrile and methacrylonitrile; vinyl halides such as vinyl chloride, vinyl bromide, and chloroprene; vinyl acetate; alkenes such as ethylene, propylene, butylene, and isobutylene; and polyfunctional monomers such as diallyl phthalate, triallyl cyanurate, triallyl isocyanurate, and divinylbenzene. These vinyl-based monomers A described above may be used alone or in combination of two or more. Among the above described vinyl-based monomers A, styrene is particularly preferable. In the case A, the structural unit derived from the vinyl-based monomer A in the diene-based rubber is a discretionarily selected component. In the case A, the diene-based rubber may consist only of the structural unit derived from a diene-based monomer.

In the case A, the diene-based rubber may be butadiene rubber (also referred to as polybutadiene rubber) which is constituted by a structural unit derived from 1,3-butadiene or butadiene-styrene rubber (also referred to as polystyrene-butadiene) which is a copolymer of 1,3-butadiene and styrene, or butadiene rubber. According to the above feature, since the fine polymer particles (A) contain the diene-based rubber, an intended effect can be further brought about. The butadiene-styrene rubber is more preferable in that the butadiene-styrene rubber makes it possible to, by adjustment of a refractive index, increase transparency of a resulting cured product.

Among 100% by weight of the butadiene-styrene rubber, (i) the butadiene-styrene rubber may contain more than 50% by weight but not more than 100% by weight of a structural unit derived from butadiene and not less than 0% by weight but less than 50% by weight of a structural unit derived from styrene, (ii) the butadiene-styrene rubber may contain 60% by weight to 100% by weight of a structural unit derived from butadiene and 0% by weight to 40% by weight of a structural unit derived from styrene, (iii) the butadiene-styrene rubber may contain 70% by weight to 100% by weight of a structural unit derived from butadiene and 0% by weight to 30% by weight of a structural unit derived from styrene, (iv) the butadiene-styrene rubber may contain 80% by weight to 100% by weight of a structural unit derived from butadiene and 0% by weight to 20% by weight of a structural unit derived from styrene, and (v) the butadiene-styrene rubber may contain 90% by weight to 100% by weight of a structural unit derived from butadiene and 0% by weight to 10% by weight of a structural unit derived from styrene.

A case where the elastic body contains a (meth)acrylate-based rubber (case B) will be described. The case B allows wide-ranging polymer design for the elastic body by combinations of many types of monomers.

The (meth)acrylate-based rubber is an elastic body containing, as a structural unit, a structural unit derived from a (meth)acrylate-based monomer. In the case B, among 100% by weight of structural units, (i) the (meth)acrylate-based rubber may contain 50% by weight to 100% by weight of a structural unit derived from a (meth)acrylate-based monomer and 0% by weight to 50% by weight of a structural unit derived from a vinyl-based monomer that is not a (meth)acrylate-based monomer and that is copolymerizable with a (meth)acrylate-based monomer, (ii) the (meth)acrylate-based rubber may contain more than 50% by weight but not more than 100% by weight of a structural unit derived from a (meth)acrylate-based monomer and not less than 0% by weight but less than 50% by weight of a structural unit derived from a vinyl-based monomer that is not a (meth)acrylate-based monomer and that is copolymerizable with a (meth)acrylate-based monomer, (iii) the (meth)acrylate-based rubber may contain 60% by weight to 100% by weight of a structural unit derived from a (meth)acrylate-based monomer and 0% by weight to 40% by weight of a structural unit derived from a vinyl-based monomer that is not a (meth)acrylate-based monomer and that is copolymerizable with a (meth)acrylate-based monomer, (iv) the (meth)acrylate-based rubber may contain 70% by weight to 100% by weight of a structural unit derived from a (meth)acrylate-based monomer and 0% by weight to 30% by weight of a structural unit derived from a vinyl-based monomer that is not a (meth)acrylate-based monomer and that is copolymerizable with a (meth)acrylate-based monomer, (v) the (meth)acrylate-based rubber may contain 80% by weight to 100% by weight of a structural unit derived from a (meth)acrylate-based monomer and 0% by weight to 20% by weight of a structural unit derived from a vinyl-based monomer that is not a (meth)acrylate-based monomer and that is copolymerizable with a (meth)acrylate-based monomer, (vi) the (meth)acrylate-based rubber may contain 90% by weight to 100% by weight of a structural unit derived from a (meth)acrylate-based monomer and 0% by weight to 10% by weight of a structural unit derived from a vinyl-based monomer that is not a (meth)acrylate-based monomer and that is copolymerizable with a (meth)acrylate-based monomer, and (vii) the (meth)acrylate-based rubber may consist only of a structural unit derived from a (meth)acrylate-based monomer.

In the case B, the (meth)acrylate-based rubber may contain, as a structural unit, a structural unit derived from a diene-based monomer in an amount smaller than the amount of the structural unit derived from the (meth)acrylate-based monomer.

Examples of the (meth)acrylate-based monomer encompass: alkyl (meth)acrylates such as methyl (meth)acrylate, ethyl (meth)acrylate, butyl (meth)acrylate, 2-ethylhexyl (meth)acrylate, octyl (meth)acrylate, dodecyl (meth)acrylate, stearyl (meth)acrylate, and behenyl (meth)acrylate; aromatic ring-containing (meth)acrylates such as phenoxyethyl (meth)acrylate and benzyl (meth)acrylate; hydroxyalkyl (meth)acrylates such as 2-hydroxyethyl (meth)acrylate and 4-hydroxybutyl (meth)acrylate; glycidyl (meth)acrylates such as glycidyl (meth)acrylate and glycidyl alkyl (meth)acrylate; alkoxy alkyl (meth)acrylates; allyl alkyl (meth)acrylates such as allyl (meth)acrylate and allyl alkyl (meth)acrylate; and polyfunctional (meth)acrylates such as monoethylene glycol di(meth)acrylate, triethylene glycol di(meth)acrylate, and tetraethylene glycol di(meth)acrylate. These (meth)acrylate-based monomers may be used alone or in combination of two or more. Out of these (meth)acrylate-based monomers, ethyl (meth)acrylate, butyl (meth)acrylate, and 2-ethylhexyl (meth)acrylate are preferable, and butyl (meth)acrylate is more preferable.

In the case B, the (meth)acrylate-based rubber may be at least one selected from the group consisting of ethyl (meth)acrylate rubbers, butyl (meth)acrylate rubbers, and 2-ethylhexyl (meth)acrylate rubbers, or a butyl (meth)acrylate rubber. An ethyl (meth)acrylate rubber is a rubber composed of structural units derived from ethyl (meth)acrylate(s), a butyl (meth)acrylate rubber is a rubber composed of structural units derived from butyl (meth)acrylate(s), and a 2-ethylhexyl (meth)acrylate rubber is a rubber composed of structural units derived from 2-ethylhexyl (meth)acrylate(s). According to the configuration, a glass transition temperature (Tg) of the elastic body is low, and therefore fine polymer particles (A) and a composition having low Tg are obtained. As a result, (i) a resulting composition can provide a cured product having excellent toughness, and (ii) it is possible to cause the composition to have a lower viscosity.

Examples of the vinyl-based monomer (hereinafter also referred to as vinyl-based monomer B) which is different from the (meth)acrylate-based monomer and which is copolymerizable with the (meth)acrylate-based monomer encompass the monomers listed as the examples of the vinyl-based monomer A. Such vinyl-based monomers B may be used alone or in combination of two or more. Out of such vinyl-based monomers B, styrene is particularly preferable. In the case B, the structural unit derived from the vinyl-based monomer B in the (meth)acrylate-based rubber is a discretionarily selected component. In the case B, the (meth)acrylate-based rubber may consist only of a structural unit derived from a (meth)acrylate-based monomer.

A case where the elastic body contains an organosiloxane-based rubber (case C) will be described. In the case C, a resulting composition can provide a cured product which has sufficient heat resistance and excellent impact resistance at low temperatures.

Examples of the organosiloxane-based rubber encompass (i) organosiloxane-based polymers composed of alkyl or aryl disubstituted silyloxy units, such as dimethylsilyloxy, diethylsilyloxy, methylphenylsilyloxy, diphenylsilyloxy, and dimethylsilyloxy-diphenylsilyloxy, and (ii) organosiloxane-based polymers composed of alkyl or aryl monosubstituted silyloxy units, such as organohydrogensilyloxy in which some of sidechain alkyls have been substituted with hydrogen atoms. These organosiloxane-based polymers may be used alone or in combination of two or more.

In the present disclosure, a polymer composed of dimethylsilyloxy units is referred to as a dimethylsilyloxy rubber, a polymer composed of methylphenylsilyloxy units is referred to as a methylphenylsilyloxy rubber, and a polymer composed of dimethylsilyloxy units and diphenylsilyloxy units is referred to as a dimethylsilyloxy-diphenylsilyloxy rubber. In the case C, the organosiloxane-based rubber may be (i) at least one selected from the group consisting of dimethylsilyloxy rubbers, methylphenylsilyloxy rubbers and dimethylsilyloxy-diphenylsilyloxy rubbers, because a resulting composition can provide a cured product which has excellent heat resistance, or (ii) a dimethylsilyloxy rubber because it can be easily obtained and is economical.

In the case C, it is preferable that the fine polymer particles (A) contain an organosiloxane-based rubber in an amount of not less than 80% by weight, or not less than 90% by weight, with respect to 100% by weight of the elastic body contained in the fine polymer particles (A). With this feature, a resulting composition can provide a cured product that has excellent heat resistance.

The elastic body may further include an elastic body which is not diene-based rubbers, (meth)acrylate-based rubbers, and organosiloxane-based rubbers. Examples of the elastic body which is not diene-based rubbers, (meth)acrylate-based rubbers, and organosiloxane-based rubbers encompass natural rubbers.

In one or more embodiments of the present invention, the elastic body may be at least one selected from the group consisting of butadiene rubbers, butadiene-styrene rubbers, butadiene-(meth)acrylate rubbers, ethyl (meth)acrylate rubbers, butyl (meth)acrylate rubbers, 2-ethylhexyl (meth)acrylate rubbers, dimethylsilyloxy rubbers, methylphenylsilyloxy rubbers, and dimethylsilyloxy-diphenylsilyloxy rubbers, or at least one selected from the group consisting of butadiene rubbers, butadiene-styrene rubbers, butyl (meth)acrylate rubbers, and dimethylsilyloxy rubbers.

### (Crosslinked Structure of Elastic Body)

The elastic body may have a crosslinked structure introduced therein, from the viewpoint of maintaining stable dispersion of the fine polymer particles (A) in the composition. It is possible to employ a generally used method to introduce a crosslinked structure into the elastic body. Examples of such a generally used method encompass the following. That is, in production of the elastic body, a crosslinking monomer(s), such as a polyfunctional monomer and/or a mercapto group-containing compound, is/are mixed with a monomer which can constitute the elastic body, and then polymerization is carried out. In the present disclosure, producing a polymer such as the elastic body is also referred to as forming a polymer by polymerization.

A method of introducing a crosslinked structure into an organosiloxane-based rubber includes the following methods: (A) a method that involves using a polyfunctional alkoxysilane compound in combination with another material during formation of the organosiloxane-based rubber by polymerization: (B) a method that involves introducing, into the organosiloxane-based rubber, a reactive group (e.g., (i) mercapto group, (ii) vinyl group having reactivity, and the like), and then adding (i) an organic peroxide, (ii) a polymerizable vinyl monomer, or the like to the obtained reaction product to cause a radical reaction; and (C) a method that involves, during formation of the organosiloxane-based rubber by polymerization, mixing a crosslinking monomer(s), such as a polyfunctional monomer and/or a mercapto group-containing compound, together with another material and then carrying out polymerization.

The polyfunctional monomer is a monomer that has, in its molecule, at least two polymerizable unsaturated bonds. The polymerizable unsaturated bond may be a carbon-carbon double bond. Examples of the polyfunctional monomer exclude butadiene and include (meth)acrylates having an ethylenically unsaturated double bond(s), such as allyl alkyl (meth)acrylates and allyl oxyalkyl (meth)acrylates. Examples of a monomer having two (meth)acrylic groups encompass ethylene glycol di(meth)acrylate, butylene glycol di(meth)acrylate, butanediol di(meth)acrylate, hexanediol di(meth)acrylate, cyclohexane dimethanol di(meth)acrylate, and polyethylene glycol di(meth)acrylates. Examples of the polyethylene glycol di(meth)acrylates encompass triethylene glycol di(meth)acrylate, tripropylene glycol di(meth)acrylate, tetraethylene glycol di(meth)acrylate, and polyethylene glycol (600) di(meth)acrylate. Examples of a monomer having three (meth)acrylic groups encompass alkoxylated trimethylolpropane tri(meth)acrylates, glycerol propoxy tri(meth)acrylate, pentaerythritol tri(meth)acrylate, and tris(2-hydroxyethyl)isocyanurate tri(meth)acrylate. Examples of the alkoxylated trimethylolpropane tri(meth)acrylates encompass trimethylolpropane tri(meth)acrylate and trimethylolpropane triethoxy tri(meth)acrylate. Examples of a monomer having four (meth)acrylic groups encompass pentaerythritol tetra(meth)acrylate and ditrimethylolpropane tetra(meth)acrylate. Examples of a monomer having five (meth)acrylic groups encompass dipentaerythritol penta(meth)acrylate. Examples of a monomer having six (meth)acrylic groups encompass ditrimethylolpropane hexa(meth)acrylate. Examples of the polyfunctional monomer also encompass diallyl phthalate, triallyl cyanurate, triallyl isocyanurate, and divinylbenzene. Note that the “polymerizable unsaturated bond” can be referred to also as an “unsaturated bond having polymerizability”, and is intended to mean an unsaturated bond that can be an origin of a polymerization reaction by a radical or the like.

Out of the above polyfunctional monomers, examples of a polyfunctional monomer which can be used to form the elastic body by polymerization encompass allyl methacrylate, ethylene glycol di(meth)acrylate, butylene glycol di(meth)acrylate, butanediol di(meth)acrylate, hexanediol di(meth)acrylate, cyclohexane dimethanol di(meth)acrylate, and polyethylene glycol di(meth)acrylates. Those polyfunctional monomers may be used alone or in combination of two or more.

Examples of the mercapto group-containing compound encompass alkyl group-substituted mercaptan, allyl group-substituted mercaptan, aryl group-substituted mercaptan, hydroxy group-substituted mercaptan, alkoxy group-substituted mercaptan, cyano group-substituted mercaptan, amino group-substituted mercaptan, silyl group-substituted mercaptan, acid radical-substituted mercaptan, halo group-substituted mercaptan, and acyl group-substituted mercaptan. The alkyl group-substituted mercaptan may be alkyl group-substituted mercaptan having 1 to 20 carbon atoms, or alkyl group-substituted mercaptan having 1 to 10 carbon atoms. The aryl group-substituted mercaptan may be phenyl group-substituted mercaptan. The alkoxy group-substituted mercaptan may be alkoxy group-substituted mercaptan having 1 to 20 carbon atoms, or alkoxy group-substituted mercaptan having 1 to 10 carbon atoms. The acid radical-substituted mercaptan may be alkyl group-substituted mercaptan having a carboxyl group and 1 to 10 carbon atoms or aryl group-substituted mercaptan having a carboxyl group and 1 to 12 carbon atoms.

### (Glass Transition Temperature of Elastic Body)

The elastic body may have a glass transition temperature of not higher than 80° C., not higher than 70° C., not higher than 60° C., not higher than 50° C., not higher than 40° C., not higher than 30° C., not higher than 20° C., not higher than 10° C., not higher than 0° C., not higher than −20° C., not higher than −40° C., not higher than −45° C., not higher than −50° C., not higher than −55° C., not higher than −60° C., not higher than −65° C., not higher than −70° C., not higher than −75° C., not higher than −80° C., not higher than −85° C., not higher than −90° C., not higher than −95° C., not higher than −100° C., not higher than −105° C., not higher than −110° C., not higher than −115° C., not higher than −120° C., or not higher than −125° C. In the present disclosure, the “glass transition temperature” may be referred to as “Tg”. With this feature, it is possible to obtain fine polymer particles (A) having low Tg and a composition having low Tg. As a result, a resulting composition can provide a cured product which has excellent toughness. According to the above feature, the resulting composition can have a lower viscosity. The Tg of the elastic body can be obtained by carrying out viscoelasticity measurement with use of a planar plate made of the fine polymer particles (A). Specifically, the Tg can be measured as follows: (1) a graph of tan δ is obtained by carrying out dynamic viscoelasticity measurement with respect to a planar plate made of the fine polymer particles (A), with use of a dynamic viscoelasticity measurement device (for example, DVA-200, manufactured by IT Keisoku Seigyo Kabushikigaisha) under a tension condition; and (2) in the graph of tan δ thus obtained, the peak temperature of tan δ is regarded as the glass transition temperature. Note, here, that in a case where a plurality of peaks are found in the graph of tan δ, the lowest peak temperature is regarded as the glass transition temperature of the elastic body.

In view of prevention of a decrease in elastic modulus (i.e., a decrease in rigidity) of a resulting cured product, i.e., in view of obtainment of the cured product which has a sufficient elastic modulus (rigidity), the Tg of the elastic body may be higher than 0° C., not lower than 20° C., not lower than 50° C., not lower than 80° C., or not lower than 120° C.

The Tg of the elastic body can be determined by, for example, the composition of the structural unit contained in the elastic body. In other words, it is possible to adjust the Tg of the resulting elastic body by changing the composition of the monomer used to produce (form by polymerization) the elastic body.

Note, here, that monomers each of which, when polymerized to form a homopolymer (i.e., a polymer obtained by polymerizing only one type of monomer), provides a homopolymer having a Tg of higher than 0° C. will be referred to as a monomer group “a”. Note also that monomers each of which, when polymerized to form a homopolymer (i.e., a polymer obtained by polymerizing only one type of monomer), provides a homopolymer having a Tg of lower than 0° C. will be referred to as a monomer group “b”. Note also that an elastic body containing (i) one or more structural units derived from at least one type of monomer selected from the monomer group “a” in an amount of 50% by weight to 100% by weight (more preferably 65% by weight to 99% by weight) and (ii) one or more structural units derived from at least one type of monomer selected from the monomer group “b” in an amount of 0% by weight to 50% by weight (more preferably 1% by weight to 35% by weight) will be referred to as an elastic body G. The elastic body G has a Tg higher than 0° C. In a case where the elastic body includes the elastic body G, a resulting composition can provide a cured product which has sufficient rigidity.

Also in a case where the Tg of the elastic body is higher than 0° C., it is preferable that the crosslinked structure be introduced in the elastic body. Examples of a method of introducing the crosslinked structure into the elastic body encompass the above-described methods.

Examples of the monomers (hereinafter sometimes referred to as “monomer(s) “a””) which can be included in the monomer group “a” encompass, but are not limited to, unsubstituted vinyl aromatic compounds such as styrene and 2-vinyl naphthalene; vinyl-substituted aromatic compounds such as α-methylstyrene; ring-alkylated vinyl aromatic compounds such as 3-methylstyrene, 4-methylstyrene, 2,4-dimethylstyrene, 2,5-dimethylstyrene, 3,5-dimethylstyrene, and 2,4,6-trimethylstyrene; ring-alkoxylated vinyl aromatic compounds such as 4-methoxystyrene and 4-ethoxystyrene; ring-halogenated vinyl aromatic compounds such as 2-chlorostyrene and 3-chlorostyrene; ring-ester-substituted vinyl aromatic compounds such as 4-acetoxy styrene; ring-hydroxylated vinyl aromatic compounds such as 4-hydroxystyrene; vinyl esters such as vinyl benzoate and vinyl cyclohexanoate; vinyl halides such as vinyl chloride; aromatic monomers such as acenaphthalene and indene; alkyl methacrylates such as methyl methacrylate, ethyl methacrylate, and isopropyl methacrylate; aromatic methacrylates such as phenyl methacrylate; methacrylates such as isobornyl methacrylate and trimethylsilyl methacrylate; methacrylic acid derivative-containing methacryl monomers such as methacrylonitrile; certain types of acrylic acid esters such as isobornyl acrylate and tert-butyl acrylate; and acrylic acid derivative-containing acrylic monomers such as acrylonitrile. Examples of the monomers which can be included in the monomer group “a” further encompass monomers each of which, when polymerized to form a homopolymer, can provide a homopolymer having a Tg of not lower than 120° C., such as acrylamide, isopropyl acrylamide, N-vinylpyrrolidone, isobornyl methacrylate, dicyclopentanyl methacrylate, 2-methyl-2-adamanthyl methacrylate, 1-adamanthyl acrylate, and 1-adamanthyl methacrylate. These monomers “a” may be used alone or in combination of two or more.

Examples of monomers (hereinafter sometimes referred to as “monomer(s) “b””) which can be included in the monomer group “b” encompass ethyl acrylate, butyl acrylate, 2-ethylhexyl acrylate, octyl (meth)acrylate, dodecyl (meth)acrylate, 2-hydroxyethyl acrylate, and 4-hydroxybutyl acrylate. These monomers “b” may be used alone or in combination of two or more. Out of these monomers “b”, ethyl acrylate, butyl acrylate, and 2-ethylhexyl acrylate are particularly preferable.

### (Volume-Average Particle Size of Elastic Body)

The elastic body may have a volume-average particle size of 0.03 μm to 50.00 μm, 0.05 μm to 10.00 μm, 0.08 μm to 2.00 μm, 0.10 μm to 1.00 μm, 0.10 μm to 0.80 μm, or 0.10 μm to 0.50 μm. In a case where the volume-average particle size of the elastic body is not less than 0.03 μm, the elastic body which has a desired volume-average particle size can be stably obtained. In a case where the volume-average particle size of the elastic body is not more than 50.00 μm, a resulting cured product has favorable heat resistance and impact resistance. The volume-average particle size of the elastic body can be measured with use of a dynamic light scattering type particle size distribution measurement apparatus using, as a test specimen, an aqueous latex containing the elastic body.

### (Proportion of Elastic Body)

A proportion of the elastic body contained in the fine polymer particles (A) may be 40% by weight to 97% by weight, 60% by weight to 95% by weight, or 70% by weight to 93% by weight, where 100% by weight represents the entirety of the fine polymer particles (A). In a case where the proportion of the elastic body is not less than 40% by weight, a resulting composition can provide a cured product which has excellent toughness and excellent impact resistance. In a case where the proportion of the elastic body is not more than 97% by weight, the fine polymer particles (A) do not agglutinate easily, and therefore a composition containing the fine polymer particles (A) does not have a high viscosity, and consequently, a resulting composition can have excellent handleability.

### (Gel Content of Elastic Body)

The elastic body may be one that can swell in an appropriate solvent but is substantially insoluble in the appropriate solvent. The elastic body may be insoluble in the low molecular weight compound (B) used and in a matrix resin (D) described later.

The elastic body may have a gel content of not less than 60% by weight, not less than 80% by weight, not less than 90% by weight, or not less than 95% by weight. In a case where the gel content of the elastic body falls within the above range, a resulting composition can provide a cured product which has excellent toughness.

In the present disclosure, a method of calculating the gel content is as follows. First, an aqueous latex containing the fine polymer particles (A) is obtained. Next, a powdery and/or granular material of the fine polymer particles (A) is obtained from the aqueous latex. A method of obtaining the powdery and/or granular material of the fine polymer particles (A) from the aqueous latex is not limited to any particular one, and examples thereof encompass a method of obtaining the powdery and/or granular material of the fine polymer particles (A) by (i) causing the fine polymer particles (A) in the aqueous latex to agglutinate, (ii) dehydrating the agglutinate thus obtained, and (iii) further drying the agglutinate. Next, 2.0 g of the powdery and/or granular material of the fine polymer particles (A) is dissolved in 50 mL of methyl ethyl ketone (MEK). The MEK solution of the powder thus obtained is separated into a part soluble in MEK (MEK-soluble part) and a part insoluble in MEK (MEK-insoluble part). Specifically, the obtained MEK solution of the powder is subjected to centrifugal separation with use of a centrifugal separator (CP60E, manufactured by Hitachi Koki Co., Ltd.) at 30,000 rpm for 1 hour, and thereby separated into the MEK-soluble part and the MEK-insoluble part. Note, here, that three sets of centrifugal separations are carried out in total. The weight of the MEK-soluble part and the weight of the MEK-insoluble part are measured, and then the gel content is calculated with use of the following expression.

Gel content (%)=(weight of methyl ethyl ketone insoluble part)/{(weight of methyl ethyl ketone insoluble part)+(weight of methyl ethyl ketone soluble part)}×100

### (Variations of Elastic Body)

In one or more embodiments of the present invention, the “elastic body” of the fine polymer particles (A) may be composed of one type of elastic body which has a structural unit having identical composition. In such a case, the “elastic body” of the fine polymer particles (A) may be one selected from the group consisting of diene-based rubbers, (meth)acrylate-based rubbers, and organosiloxane-based rubbers.

In one or more embodiments of the present invention, the “elastic body” of the fine polymer particles (A) may be composed of a plurality of types of elastic bodies which differ in structural unit composition from each other. In such a case, the “elastic body” of the fine polymer particles (A) may be two or more types selected from the group consisting of diene-based rubbers, (meth)acrylate-based rubbers, and organosiloxane-based rubbers. In such a case, the “elastic body” of the fine polymer particles (A) may be one selected from the group consisting of diene-based rubbers, (meth)acrylate-based rubbers, and organosiloxane-based rubbers. In other words, the “elastic body” of the fine polymer particles (A) may be a plurality of types, which differ in structural unit composition from each other, of the following rubbers: diene-based rubbers, (meth)acrylate-based rubbers, and organosiloxane-based rubbers.

In one or more embodiments of the present invention, a case where the “elastic body” of the fine polymer particles (A) is composed of a plurality of types of elastic bodies which differ in structural unit composition from each other will be described. In this case, the plurality of types of elastic bodies will be referred to as an elastic body₁, an elastic body₂, . . . and an elastic bodyₙ, respectively. Note, here, that “n” is an integer of 2 or more. The “elastic body” of the fine polymer particles (A) may include a complex of the elastic body₁, the elastic body₂, . . . , and the elastic bodyₙ which have been separately formed by polymerization. The “elastic body” of the fine polymer particles (A) may include one elastic body obtained by forming the elastic body₁, the elastic body₂, . . . , and the elastic bodyₙ in order by polymerization. Forming a plurality of elastic bodies (polymers) by polymerization in order in this manner is also referred to as multistage polymerization. One elastic body obtained by multistage polymerization of a plurality of types of elastic bodies is also referred to as a multistage-polymerization elastic body. A method of producing a multistage-polymerization elastic body will be later described in detail.

A multistage-polymerization elastic body constituted by the elastic body₁, the elastic body₂, . . . and the elastic body, will be described. In the multistage-polymerization elastic body, the elastic bodyₙ can cover at least part of an elastic bodyₙ₋₁ or the whole of the elastic bodyₙ₋₁. In the multistage-polymerization elastic body, part of the elastic body, may be located inside the elastic bodyₙ₋₁.

In the multistage-polymerization elastic body, the plurality of elastic bodies may form a layer structure. For example, in a case where the multistage-polymerization elastic body is constituted by the elastic body₁, the elastic body₂, and an elastic body₃, aspects of one or more embodiments of the present invention also include an aspect in which the elastic body₁ forms the innermost layer, a layer of the elastic body₂ is formed on the outer side of the elastic body₁, and a layer of the elastic body₃ is formed on the outer side of the layer of the elastic body₂ as the outermost layer of the elastic body. Thus, it can also be said that the multistage-polymerization elastic body in which the plurality of elastic bodies form a layer structure is a multilayered elastic body. In other words, in one or more embodiments of the present invention, the “elastic body” of the fine polymer particles (A) may include (i) a complex of a plurality of types of elastic bodies, (ii) a multistage-polymerization elastic body, and/or (iii) a multilayered elastic body.

### (Surface-Crosslinked Polymer)

The elastic body may further include a surface-crosslinked polymer in addition to at least one type of rubber selected from the group consisting of diene-based rubbers, (meth)acrylate-based rubbers, and organosiloxane-based rubbers. In the following description, a part of the elastic body which contains the above described rubber as a main component is sometimes referred to as an “elastic core of the elastic body” in order to distinguish the elastic core from the surface-crosslinked polymer contained in the elastic body. In other words, the elastic body may contain (i) an elastic core of the elastic body, the elastic core being obtained by polymerizing at least one type of monomer, the elastic core being selected from the group consisting of diene-based rubbers, (meth)acrylate-based rubbers, and organosiloxane-based rubbers and (ii) a surface-crosslinked polymer which is obtained by polymerizing at least one type of monomer selected from the group consisting of a polyfunctional monomer that has, in its molecule, at least two polymerizable unsaturated bonds and a vinyl-based monomer other than the polyfunctional monomer. One or more embodiments of the present invention will be described with reference to an example case in which the elastic body further has a surface-crosslinked polymer, in addition to the elastic core of the elastic body. In this case, (i) an anti-blocking property can be improved in the production of the fine polymer particles (A); and (ii) the dispersibility of the fine polymer particles (A) in the composition becomes more favorable. Reasons for these are not limited to any particular ones, but can be inferred as follows. By the surface-crosslinked polymer covering at least part of the elastic core of the elastic body, the exposed area of the elastic core of the elastic body of the fine polymer particles (A) is reduced. Consequently, the elastic body is less likely to adhere to another elastic body, and therefore the dispersibility of the fine polymer particles (A) is improved.

In a case where the elastic body includes the surface-crosslinked polymer, the following effects can be further brought about: (i) an effect of reducing the viscosity of the present composition; (ii) an effect of increasing the crosslinking density of the entire elastic body; and (iii) an effect of increasing the graft efficiency of the graft part. Note that the crosslinking density of the elastic core of the elastic body is intended to mean a degree of the number of crosslinked structures in the entirety of the elastic core of the elastic body.

The surface-crosslinked polymer is constituted by a polymer containing, as structural units, (i) a structural unit(s) derived from a polyfunctional monomer(s) in an amount of 30% by weight to 100% by weight and (ii) a structural unit(s) derived from vinyl-based monomer(s), other than the structural unit(s) derived from polyfunctional monomer(s), in an amount of 0% by weight to 70% by weight, which total 100% by weight.

Examples of the polyfunctional monomer which can be used to form the surface-crosslinked polymer by polymerization encompass the polyfunctional monomers exemplified in the section “Crosslinked structure of elastic body” described above. Out of such polyfunctional monomers, examples of a polyfunctional monomer which can be used to form the surface-crosslinked polymer by polymerization encompass allyl methacrylate, ethylene glycol di(meth)acrylate, butylene glycol di(meth)acrylate (such as 1,3-butylene glycol dimethacrylate), butanediol di(meth)acrylate, hexanediol di(meth)acrylate, cyclohexane dimethanol di(meth)acrylate, and polyethylene glycol di(meth)acrylates. Those polyfunctional monomers may be used alone or in combination of two or more.

The elastic body may include a surface-crosslinked polymer which has been formed by polymerization independently of formation of the elastic core of the elastic body by polymerization, or may include a surface-crosslinked polymer which has been formed together with the elastic core of the elastic body by polymerization. In other words, the fine polymer particles (A) may be a multistage polymer obtained by forming the elastic core of the elastic body and the surface-crosslinked polymer together by polymerization and then forming the graft part by polymerization. The fine polymer particles (A) may be a multistage polymer obtained by forming the elastic core of the elastic body, the surface-crosslinked polymer, and the graft part in this order by multistage polymerization. In any of these aspects, the surface-crosslinked polymer can cover at least part of the elastic core of the elastic body.

The surface-crosslinked polymer can be regarded as part of the elastic body and, in contrast to the elastic core of the elastic body, the surface-crosslinked polymer can be referred to also as a surface-crosslinked polymer part of the elastic body. In a case where the elastic body contains the surface-crosslinked polymer, the graft part may (i) be grafted to the elastic body other than the surface-crosslinked polymer (i.e., the elastic core of the elastic body), (ii) be grafted to the surface-crosslinked polymer, or (iii) be grafted to both the elastic body other than the surface-crosslinked polymer (i.e., the elastic core of the elastic body) and the surface-crosslinked polymer. In a case where the elastic body contains the surface-crosslinked polymer, the above-described volume-average particle size of the elastic body is intended to mean the volume-average particle size of the elastic body including the surface-crosslinked polymer.

### (Graft Part)

In the present disclosure, a polymer grafted to the elastic body is referred to as a graft part. The graft part may be (or may contain) a polymer that contains, as one or more structural units, one or more structural units derived from at least one type of monomer selected from the group consisting of aromatic vinyl monomers, vinyl cyanide monomers, and (meth)acrylate monomers. The graft part having the above feature can play various roles. The “various roles” are, for example, (i) improving compatibility between the fine polymer particles (A) and the other organic components (such as a low molecular weight compound (B) and a matrix resin (D) which will be described later) of the composition, (ii) improving the dispersibility of the fine polymer particles (A) in the other organic components of the composition, and (iii) allowing the fine polymer particles (A) to be dispersed in the form of primary particles in a composition or a cured product thereof.

Specific examples of the aromatic vinyl monomers encompass styrene, α-methylstyrene, p-methylstyrene, and divinylbenzene.

Specific examples of the vinyl cyanide monomers encompass acrylonitrile and methacrylonitrile.

Specific examples of the (meth)acrylate monomers encompass methyl (meth)acrylate, ethyl (meth)acrylate, butyl (meth)acrylate, hydroxyethyl (meth)acrylate, and hydroxybutyl (meth)acrylate. The term “(meth)acrylate” herein is intended to mean acrylate and/or methacrylate.

The at least one type of monomer selected from the group consisting of aromatic vinyl monomers, vinyl cyanide monomers, and (meth)acrylate monomers may be used alone or in combination of two or more.

The graft part may contain, as one or more structural units, a structural unit(s) derived from aromatic vinyl monomer(s), a structural unit(s) derived from vinyl cyanide monomer(s), and/or a structural unit(s) derived from (meth)acrylate monomer(s) in an amount of 10% by weight to 95% by weight in total, 30% by weight to 92% by weight in total, 50% by weight to 90% by weight in total, 60% by weight to 87% by weight in total, or 70% by weight to 85% by weight in total, with respect to 100% by weight of the polymer contained in the graft part.

The graft part may contain, as a structural unit, a structural unit derived from a polyfunctional monomer that has, in its molecule, at least two polymerizable unsaturated bonds. The polyfunctional monomer can crosslink a polymer obtained by polymerization of a monofunctional monomer in production of the graft part. Therefore, it can also be said that the polyfunctional monomer is a “crosslinking agent”.

In a case where the graft part contains a structural unit derived from a polyfunctional monomer, there are the following advantages, for example: (i) it is possible to prevent swelling of the fine polymer particles (A) in the composition; (ii) since the composition has a low viscosity, the composition tends to have favorable handleability; and (iii) the dispersibility of the fine polymer particles (A) in the other organic components of the composition improves.

In a case where the graft part does not contain a structural unit derived from a polyfunctional monomer, a resulting composition can provide a cured product which has more excellent toughness and more excellent impact resistance, as compared to a case where the graft part contains a structural unit derived from a polyfunctional monomer.

Examples of the polyfunctional monomer that has, in its molecule, at least two polymerizable unsaturated bonds encompass the polyfunctional monomers exemplified in the section “Crosslinked structure of elastic body” described above.

Out of such polyfunctional monomers that each have, in its molecule, at least two polymerizable unsaturated bonds, examples of a polyfunctional monomer which can be used to form the graft part by polymerization encompass allyl methacrylate, ethylene glycol di(meth)acrylate, butylene glycol di(meth)acrylate, butanediol di(meth)acrylate, hexanediol di(meth)acrylate, cyclohexane dimethanol di(meth)acrylate, and polyethylene glycol di(meth)acrylates. Those polyfunctional monomers may be used alone as a second monomer, or in combination of two or more as second monomers.

The graft part may contain a structural unit(s) derived from polyfunctional monomer(s) in an amount of 1% by weight to 20% by weight, or 5% by weight to 15% by weight, with respect to 100% by weight of a polymer contained in the graft part.

The graft part may further contain, as a structural unit, a structural unit derived from a monomer having a reactive group. The monomer having a reactive group may be a monomer having at least one type of reactive group selected from the group consisting of an epoxy group, an oxetane group, a hydroxy group, an amino group, an imide group, a carboxylic acid group, a carboxylic anhydride group, a cyclic ester, a cyclic amide, a benzoxazine group, and a cyanate ester group, a monomer having at least one type of reactive group selected from the group consisting of an epoxy group, a hydroxy group, and a carboxylic acid group, or a monomer having an epoxy group. This feature makes it possible to allow the graft part of the fine polymer particles (A) and the matrix resin (D) (described later) to be chemically bonded to each other in a composition. This makes it possible to keep the fine polymer particles (A) in a well dispersed state without allowing the fine polymer particles (A) to agglutinate in the composition or a cured product thereof.

Specific examples of the monomer having epoxy group encompass glycidyl-group-containing vinyl monomers such as glycidyl (meth)acrylates, 4-hydroxybutyl (meth)acrylate glycidyl ethers, and allyl glycidyl ethers.

Specific examples of the monomer having hydroxy group encompass (a) hydroxy straight-chain alkyl (meth)acrylates (particularly preferably, hydroxy straight chain C1-C6 alkyl (meth)acrylates) such as 2-hydroxyethyl (meth)acrylates, hydroxypropyl (meth)acrylates, and 4-hydroxybutyl (meth)acrylates, (b) caprolactone-modified hydroxy (meth)acrylates, (c) hydroxy branching alkyl (meth)acrylates such as α-(hydroxymethyl) methyl acrylates and α-(hydroxymethyl) ethyl acrylates, and (d) hydroxyl-group-containing (meth)acrylates such as mono (meth)acrylates of a polyester diol (particularly preferably, saturated polyester diol) obtained from a dicarboxylic acid (e.g., phthalic acid) and a dihydric alcohol (e.g., propylene glycol). Note that the “straight chain C1-C6 alkyl” is intended to mean a straight-chain alkyl having 1 to 6 carbon atoms.

Specific examples of the monomer having a carboxylic acid group encompass (a) monocarboxylic acids such as acrylic acid, methacrylic acid, and crotonic acid, and (b) dicarboxylic acids such as maleic acid, fumaric acid, and itaconic acid. Any of the monocarboxylic acids is suitably used as the monomer having a carboxylic acid group.

These monomers having reactive group(s) may be used alone or in combination of two or more.

The graft part may contain a structural unit(s) derived from monomer(s) having reactive group(s) in an amount of 0.5% by weight to 90% by weight, 1% by weight to 50% by weight, 2% by weight to 35% by weight, or 3% by weight to 20% by weight, with respect to 100% by weight of a polymer contained in the graft part. In a case where the graft part contains, in an amount of 0.5% by weight, a structural unit(s) derived from monomer(s) having reactive group(s), among 100% by weight of a polymer contained in the graft part, a resulting composition can provide a cured product which has sufficient impact resistance. In a case where the graft part contains not more than 90% by weight of the above structural unit, a resulting composition can provide a cured product which has sufficient impact resistance, and storage stability of the composition is favorable.

The structural unit(s) derived from the monomer(s) having reactive group(s) may be contained in the graft part, or contained only in the graft part.

In formation of the graft part by polymerization, the foregoing monomers may be used alone or in combination of two or more. The graft part may contain, as a structural unit, a structural unit derived from another monomer, in addition to the structural unit(s) derived from the above-listed monomer(s).

The graft part preferably does not contain a functional group Y that is reactive with a functional group X contained in the low molecular weight compound (B) described later. According to the above feature, the composition has an advantage of having more excellent storage stability.

Note, here, that in a case where there are a plurality of types of functional groups X contained in the low molecular weight compound (B), the feature in which the “graft part does not contain a functional group Y that is reactive with a functional group X contained in the low molecular weight compound (B)” is intended to mean not to contain all of a plurality of types of functional groups Y each of which is reactive with each of the plurality of types of functional groups. Examples of a functional group reactive with an oxetane group encompass an oxetane group, a hydroxy group, an epoxy group, an amino group, an imide group, a carboxylic acid group, and a carboxylic anhydride group. Examples of a functional group reactive with a hydroxy group encompass an oxetane group, an epoxy group, an imide group, a carboxylic anhydride group, a cyclic ester group, a cyclic amide group, and a cyanate ester group. Examples of a functional group reactive with an epoxy group encompass an oxetane group, a hydroxy group, an epoxy group, an amino group, an imide group, a carboxylic acid group, and a carboxylic anhydride group. Examples of a functional group reactive with an amino group encompass an oxetane group, an epoxy group, an imide group, a carboxylic acid group, a carboxylic anhydride group, a cyclic ester group, a cyclic amide group, and a cyanate ester group. Examples of a functional group reactive with an imide group encompass an oxetane group, a hydroxy group, an epoxy group, an amino group, an imide group, a carboxylic acid group, a carboxylic anhydride group, a cyclic ester group, a cyclic amide group, and a cyanate ester group. Examples of a functional group reactive with a carboxylic acid group encompass an oxetane group, a hydroxy group, an epoxy group, an amino group, an imide group, a carboxylic acid group, a carboxylic anhydride group, a cyclic ester group, a cyclic amide group, and a cyanate ester group. Examples of a functional group reactive with a carboxylic anhydride group encompass an oxetane group, a hydroxy group, an epoxy group, an amino group, an imide group, a carboxylic acid group, a carboxylic anhydride group, a cyclic ester group, a cyclic amide group, and a cyanate ester group. Examples of a functional group reactive with a cyclic ester group encompass an oxetane group, a hydroxy group, an epoxy group, an amino group, an imide group, a carboxylic acid group, a carboxylic anhydride group, a cyclic ester group, a cyclic amide group, and a cyanate ester group. Examples of a functional group reactive with a cyclic amide group encompass an oxetane group, a hydroxy group, an epoxy group, an amino group, an imide group, a carboxylic acid group, a carboxylic anhydride group, a cyclic ester group, a cyclic amide group, and a cyanate ester group. Examples of a functional group reactive with a benzoxazine group encompass a benzoxazine group. Examples of a functional group reactive with a cyanate ester group encompass an oxetane group, a hydroxy group, an epoxy group, an amino group, an imide group, a carboxylic acid group, a carboxylic anhydride group, a cyclic ester group, a cyclic amide group, and a cyanate ester group.

In a case where the compound contained in the low molecular weight compound (B) has a functional group other than the functional group X, it is preferable that the graft part does not contain a functional group reactive with such a functional group other than the functional group X, in order that the composition has particularly excellent storage stability. In other words, in order that the composition has particularly excellent storage stability, the graft part preferably does not contain all of the plurality of types of functional groups which are reactive with each of all functional groups included in all compounds contained in the low molecular weight compound (B).

Examples of a functional group reactive with a (meth)acryloyl group encompass a (meth)acryloyl group and a vinyl group. Examples of a functional group reactive with a —COOCH═CH₂ group encompass a (meth)acryloyl group and a vinyl group. Examples of a functional group reactive with an aromatic group encompass a benzoxazine group. Examples of a functional group reactive with a nitrile group (excluding a cyanate ester group) encompass an oxetane group, a hydroxy group, an epoxy group, an amino group, an imide group, a carboxylic acid group, a carboxylic anhydride group, a cyclic ester group, a cyclic amide group, and a cyanate ester group. Examples of a functional group reactive with a carbonyl group (excluding a carboxylic acid group and a carboxylic anhydride group) encompass an oxetane group, a hydroxy group, an epoxy group, an amino group, an imide group, a carboxylic acid group, a carboxylic anhydride group, a cyclic ester group, a cyclic amide group, and a cyanate ester group.

### (Glass Transition Temperature of Graft Part)

The graft part may have a glass transition temperature of not higher than 190° C., not higher than 160° C., not higher than 140° C., not higher than 120° C., not higher than 80° C., not higher than 70° C., not higher than 60° C., not higher than 50° C., not higher than 40° C., not higher than 30° C., not higher than 20° C., not higher than 10° C., not higher than 0° C., not higher than −20° C., not higher than −40° C., not higher than −45° C., not higher than −50° C., not higher than −55° C., not higher than −60° C., not higher than −65° C., not higher than −70° C., not higher than −75° C., not higher than −80° C., not higher than −85° C., not higher than −90° C., not higher than −95° C., not higher than −100° C., not higher than −105° C., not higher than −110° C., not higher than −115° C., not higher than −120° C., or not higher than −125° C.

The glass transition temperature of the graft part may be not lower than −130° C., not lower than −110° C., not lower than −90° C., not lower than −70° C., not lower than −50° C., not lower than −30° C., not lower than −10° C., not lower than 0° C., not lower than 10° C., not lower than 30° C., not lower than 50° C., not lower than 70° C., not lower than 90° C., or not lower than 110° C.

The Tg of the graft part can be determined by, for example, the composition of the structural unit contained in the graft part. In other words, it is possible to adjust the Tg of a resulting graft part by changing the composition of the monomer used to produce (form by polymerization) the graft part.

The Tg of the graft part can be obtained by carrying out viscoelasticity measurement with use of a planar plate made of fine polymer particles (A). Specifically, the Tg can be measured as follows: (1) a graph of tan δ is obtained by carrying out dynamic viscoelasticity measurement with respect to a planar plate made of the fine polymer particles (A), with use of a dynamic viscoelasticity measurement device (for example, DVA-200, manufactured by IT Keisoku Seigyo Kabushikigaisha) under a tension condition; and (2) in the graph of tan δ thus obtained, the peak temperature of tan δ is regarded as the glass transition temperature. Note, here, that in a case where a plurality of peaks are found in the graph of tan δ, the highest peak temperature is regarded as the glass transition temperature of the graft part.

### (Graft Rate of Graft Part)

In one or more embodiments of the present invention, the fine polymer particles (A) may have a polymer which is identical in composition to the graft part and which is not grafted to the elastic body. In the present disclosure, the “polymer which is identical in composition to the graft part and which is not grafted to the elastic body” may be referred to as a “non-grafted polymer”. The non-grafted polymer constitutes a part of the fine polymer particles (A) in accordance with one or more embodiments of the present invention. It can also be said that the non-grafted polymer is a polymer that is not grafted to the elastic body, out of polymers produced during formation of the graft part by polymerization.

In the present disclosure, the proportion of (i) the polymer which is grafted to the elastic body to (ii) the polymers produced during the formation of the graft part by polymerization, i.e., the proportion of the graft part, is referred to as a “graft rate”. In other words, the graft rate is a value represented by the following expression: (weight of graft part)/{(weight of graft part)+(weight of non-grafted polymer)}×100.

The graft rate of the graft part may be not less than 70%, not less than 80%, or not less than 90%. In a case where the graft rate is not less than 70%, there is an advantage that the viscosity of the composition does not become too high.

In the present disclosure, the graft rate is calculated by the following method. First, an aqueous latex containing the fine polymer particles (A) is obtained. Next, a powdery and/or granular material of the fine polymer particles (A) is obtained from the aqueous latex. A specific example of a method of obtaining the powdery and/or granular material of the fine polymer particles (A) from the aqueous latex is a method of obtaining the powdery and/or granular material of the fine polymer particles (A) by (i) causing the fine polymer particles (A) in the aqueous latex to coagulate, (ii) dehydrating the coagulate thus obtained, and (iii) further drying the coagulate. Next, 2 g of the powdery and/or granular material of the fine polymer particles (A) is dissolved in 50 mL of methyl ethyl ketone (hereinafter referred to also as “MEK”). The MEK solution of the powder thus obtained is separated into a part soluble in MEK (MEK-soluble part) and a part insoluble in MEK (MEK-insoluble part). Specifically, the following steps (1) through (3) are carried out: (1) the obtained MEK solution of the powder is subjected to centrifugal separation with use of a centrifugal separator (CP60E, manufactured by Hitachi Koki Co., Ltd.) at 30,000 rpm for 1 hour, and thereby separated into an MEK-soluble part and an MEK-insoluble part; (2) the obtained MEK-soluble part and MEK are mixed together, and the obtained MEK mixture is subjected to centrifugal separation with use of the above described centrifugal separator at 30,000 rpm for 1 hour, and thereby the MEK mixture is separated into an MEK-soluble part and an MEK-insoluble part; (3) the operation of the above step (2) is repeated once again (that is, the centrifugal separation is carried out three times in total). By these operations, a concentrated MEK-soluble part is obtained. Next, 20 ml of the concentrated MEK-soluble part is mixed with 200 ml of methanol. An aqueous calcium chloride solution in which 0.01 g of calcium chloride is dissolved in water is added to the obtained mixture, and the mixture thus obtained is stirred for 1 hour. After that, the obtained mixture is separated into a methanol-soluble part and a methanol-insoluble part. The weight of the methanol-insoluble part is used as the amount of a free polymer (FP).

The graft rate is calculated with use of the following expression.

Graft rate (%)=100−[(amount of FP)/{(amount of FP)+(weight of MEK-insoluble part)}]/(weight of polymer of graft part)×10,000

Note that the weight of a polymer other than the graft part is the amount of monomer introduced for formation of the polymer other than the graft part. The polymer other than the graft part is, for example, the elastic body. In a case where the fine polymer particles (A) contain a surface-crosslinked polymer, the polymer other than the graft part includes both the elastic body and the surface-crosslinked polymer. The weight of the polymer of the graft part is the amount of monomer introduced for formation of the polymer of the graft part. In calculation of the graft rate, a method of causing the fine polymer particles (A) to coagulate is not limited to any particular one, and a method in which a solvent is used, a method in which a coagulant is used, a method in which the aqueous latex is sprayed, or the like can be employed.

### (Variations of Graft Part)

In one or more embodiments of the present invention, the graft part may be constituted by only one type of graft part which has a structural unit having identical composition. In one or more embodiments of the present invention, the graft part may be constituted by a plurality of types of graft parts which have structural units different from each other in composition.

A case where the graft part is constituted by a plurality of types of graft parts in one or more embodiments of the present invention will be described. In this case, the plurality of types of graft parts will be referred to as a graft part₁, a graft part₂, . . . a graft partₙ (“n” is an integer of 2 or more). The graft part may include a complex of the graft part₁, the graft part₂, . . . , and the graft partₙ which are separately formed by polymerization. The graft part may include a single polymer obtained by forming the graft part₁, the graft part₂, . . . , and the graft partₙ by polymerization in order. Forming a plurality of polymer parts (graft parts) by polymerization in order in this manner is also referred to as multistage polymerization. A single polymer obtained by multistage polymerization of a plurality of types of graft parts is also referred to as a multistage-polymerization graft part. A method of producing a multistage-polymerization graft part will be later described in detail.

In a case where the graft part is constituted by the plurality of types of graft parts, all of the plurality of types of graft parts do not need to be grafted to the elastic body. In a case where the graft part is constituted by the plurality of types of graft parts, it is only necessary that at least part of at least one of the plurality of types of graft parts be grafted to the elastic body. The other of the plurality of types of graft parts (the other types of graft parts) may be grafted to the at least one of the plurality of types of graft parts which is grafted to the elastic body. In a case where the graft part is constituted by the plurality of types of graft parts, the graft part may have a plurality of types of polymers (plurality of types of non-grafted polymers) which are identical in composition to the plurality of types of graft parts and which are not grafted to the elastic body.

The multistage-polymerization graft part constituted by the graft part₁, the graft part₂, . . . , and the graft partₙ will be described. In the multistage-polymerization graft part, the graft partₙ can cover at least part of a graft partₙ₋₁ or the whole of the graft partₙ₋₁. In the multistage-polymerization graft part, part of the graft partₙ may be located inside the graft partₙ₋₁.

In the multistage-polymerization graft part, the plurality of graft parts may form a layer structure. For example, in a case where the multistage-polymerization graft part is constituted by the graft part₁, the graft part₂, and a graft part₃, aspects of one or more embodiments of the present invention also include an aspect in which the graft part₁ forms the innermost layer of the graft part, a layer of the graft part₂ is formed on the outer side of the graft part₁, and a layer of the graft part₃ is formed on the outer side of the layer of the graft part₂ as the outermost layer. Thus, it can also be said that the multistage-polymerization graft part in which the plurality of graft parts form a layer structure is a multilayered graft part. In other words, in one or more embodiments of the present invention, the graft part may include (a) a complex of a plurality of types of graft parts, (b) a multistage-polymerization graft part, and/or (c) a multilayered graft part.

In a case where the elastic body and the graft part are formed in this order by polymerization in production of the fine polymer particles (A), at least part of the graft part can cover at least part of the elastic body in the resulting fine polymer particles (A). The wording “the elastic body and the graft part are formed in this order by polymerization” can be reworded as follows: the elastic body and the graft part are subjected to multistage polymerization. It can also be said that the fine polymer particles (A) obtained by multistage polymerization of the elastic body and the graft part are a multistage polymer.

In a case where the fine polymer particles (A) are constituted by a multistage polymer, the graft part can cover at least part of the elastic body or the whole of the elastic body. In a case where the fine polymer particles (A) are constituted by a multistage polymer, part of the graft part may be located inside the elastic body. At least part of the graft part may cover at least part of the elastic body. In other words, at least part of the graft part may be present on the outermost side of the fine polymer particles (A).

In a case where the fine polymer particles (A) are constituted by a multistage polymer, the elastic body and the graft part may form a layer structure. For example, aspects of one or more embodiments of the present invention also include an aspect in which the elastic body forms the innermost layer (also referred to as a core layer) and a layer of the graft part is formed on the outer side of the elastic body as the outermost layer (also referred to as a shell layer). It can also be said that a structure in which the elastic body is present as a core layer and the graft part is present as a shell layer is a core-shell structure. It can also be said that the fine polymer particles (A) that contain the elastic body and the graft part which form a layer structure (core-shell structure) are constituted by a multilayered polymer or a core-shell polymer. In other words, in one or more embodiments of the present invention, the fine polymer particles (A) may be constituted by a multistage polymer and/or a multilayered polymer or a core-shell polymer. Note, however, that the fine polymer particles (A) are not limited to the above feature, provided that the fine polymer particles (A) have the elastic body and the graft part.

A case will be described where the fine polymer particles (A) are a multistage polymer obtained by forming the elastic core of the elastic body, the surface-crosslinked polymer, and the graft part in this order by multistage polymerization (case D). In the case D, the surface-crosslinked polymer may be impregnated in (enter inside) part of the surface of the elastic core of the elastic body or may be impregnated in (enter inside) the entirety of the surface of the elastic core of the elastic body. In the case D, the graft part can cover part of the surface-crosslinked polymer or the whole of the surface-crosslinked polymer. In the case D, the graft part may form a layer of the graft part on the outer side of the surface-crosslinked polymer while part of the graft part is impregnated in (while entering inside) the surface of the surface-crosslinked polymer. In the case D, part of the graft part may form a layer of the graft part on the outer side of the elastic core of the elastic body while part of the graft part is impregnated in (while entering inside) the surface of the elastic core of the elastic body. In the case D, the elastic core of the elastic body, the surface-crosslinked polymer, and the graft part may form a layer structure. For example, aspects of one or more embodiments of the present invention also include an aspect in which the elastic core of the elastic body is present as the innermost layer (core layer), a layer of the surface-crosslinked polymer is present on the outer side of the elastic core of the elastic body as an intermediate layer, and a layer of the graft part is present on the outer side of the surface-crosslinked polymer as the outermost layer (shell layer)

### (Volume-Average Particle Size (Mv) of Fine Polymer Particles (A))

The volume-average particle size (Mv) of the fine polymer particles (A) may be 0.03 μm to 50.00 μm, 0.05 μm to 10.00 μm, 0.08 μm to 2.00 μm, 0.10 μm to 1.00 μm, 0.10 μm to 0.80 μm, or 0.10 μm to 0.50 μm, because it is possible to obtain a composition which has a desired viscosity and which is highly stable. In a case where the volume-average particle size (Mv) of the fine polymer particles (A) falls within the above range, there is also an advantage that the dispersibility of the fine polymer particles (A) in the other organic components of the composition is favorable. Note that, in the present disclosure, the “volume-average particle size (Mv) of the fine polymer particles (A)” is intended to mean the volume-average particle size of the primary particles of the fine polymer particles (A) unless otherwise mentioned. The volume-average particle size of the fine polymer particles (A) can be measured with use of a dynamic light scattering type particle size distribution measurement apparatus using, as a test specimen, an aqueous latex containing the fine polymer particles (A).

### <2-2. Method of Producing Fine Polymer Particles (A)>

The following description will discuss an example of a method for producing fine polymer particles (A). The fine polymer particles (A) can be produced, for example, as follows: after an elastic body is formed by polymerization, a polymer which constitutes a graft part is graft polymerized to the elastic body in the presence of the elastic body.

The fine polymer particles (A) can be produced by a known method, for example, a method such as an emulsion polymerization method, a suspension polymerization method, or a microsuspension polymerization method. Specifically, the formation of the elastic body by polymerization in the fine polymer particles (A), the formation of the graft part by polymerization in the fine polymer particles (A) (graft polymerization), and the formation of the surface-crosslinked polymer by polymerization in the fine polymer particles (A) can be each achieved by a known method, for example, a method such as an emulsion polymerization method, a suspension polymerization method, or a microsuspension polymerization method. Out of these methods, the emulsion polymerization method is particularly preferable as the method of producing the fine polymer particles (A). The emulsion polymerization method has the following advantages: it facilitates (i) compositional design of the fine polymer particles (A), (ii) industrial production of the fine polymer particles (A), and (iii) obtainment of an aqueous latex suitably used in the present production method (described later). A method of producing the elastic body which can be contained in the fine polymer particles (A), a method of producing the graft part which can be contained in the fine polymer particles (A), and a method of producing the surface-crosslinked polymer which can be optionally contained in the fine polymer particles (A) will be described below.

### (Method of Producing Elastic Body)

The elastic body can be produced by polymerizing at least one type of monomer selected from the group consisting of diene-based monomers, (meth)acrylate-based monomers, and organosiloxane-based monomers.

A case will be considered where the elastic body includes at least one type of elastic body selected from the group consisting of diene-based rubbers and (meth)acrylate-based rubbers. In this case, the elastic body can be produced by polymerizing at least one type of monomer selected from the group consisting of diene-based monomers and (meth)acrylate-based monomers. In this case, polymerization of monomers can be carried out by, for example, a method such as emulsion polymerization, suspension polymerization, or microsuspension polymerization. As the method of polymerization, a method disclosed in, for example, WO 2005/028546 can be used.

A case where the elastic body includes an organosiloxane-based rubber will be described. In this case, the elastic body can be produced by polymerizing an organosiloxane-based monomer. In this case, polymerization of monomers can be carried out by, for example, a method such as emulsion polymerization, suspension polymerization, or microsuspension polymerization. As the method of polymerization, a method disclosed in, for example, WO 2006/070664 can be used.

A case where the “elastic body” of the fine polymer particles (A) is constituted by a plurality of types of elastic bodies (for example, an elastic body₁, an elastic body₂, . . . , an elastic bodyₙ) will be described. In this case, a complex which is constituted by the plurality of types of elastic bodies may be produced in the following manner: the elastic body₁, the elastic body₂, . . . and the elastic bodyₙ are each formed by polymerization individually by any of the above-described methods, and then these elastic bodies are mixed and complexed. Alternatively, the elastic body₁, the elastic body₂, . . . and the elastic bodyₙ may be formed in order by multistage polymerization to produce one elastic body which is constituted by the plurality of types of elastic bodies.

The multistage polymerization of the elastic bodies will be described in detail. For example, the multistage-polymerization elastic body can be obtained by carrying out in order the following steps (1) through (4): (1) The elastic body₁ is formed by polymerization; (2) next, the elastic body₂ is formed by polymerization in the presence of the elastic body₁ to obtain a two-stage elastic body₁₊₂; (3) subsequently, an elastic body₃ is formed by polymerization in the presence of the elastic body₁₊₂ to obtain a three-stage elastic body₁₊₂₊₃; and (4) after a similar process(es) is/are carried out, the elastic bodyₙ is formed by polymerization in the presence of an elastic body₁₊₂₊ . . . ₊₍ₙ₋₁₎ to obtain a multistage-polymerization elastic body₁₊₂₊ . . . ₊ₙ.

### (Method of Producing Graft Part)

The graft part can be formed, for example, by polymerizing, by known radical polymerization in the presence of the elastic body, the monomer used to form the graft part. In a case where (i) an elastic core is obtained as an aqueous latex or (b) an elastic body containing an elastic core and a surface-crosslinked polymer is obtained as an aqueous latex, the graft part may be formed by an emulsion polymerization method. The graft part can be produced by a method disclosed in, for example, WO 2005/028546.

The method of producing the graft part in a case where the graft part is constituted by a plurality of types of graft parts (for example, a graft part₁, a graft part₂, . . . , a graft partₙ) will be described. In this case, the graft part (complex) which is constituted by the plurality of types of graft parts may be produced in the following manner: the graft part₁, the graft part₂, . . . and the graft partₙ are each formed by polymerization individually by any of the above-described methods, and then these graft parts are mixed and complexed. Alternatively, the graft part₁, the graft part₂, . . . the graft partₙ may be formed in order by multistage polymerization to produce one graft part which is constituted by the plurality of types of graft parts.

The multistage polymerization of the graft parts will be described in detail. For example, the multistage-polymerization graft part can be obtained by carrying out in order the following steps (1) through (4): (1) The graft part₁ is formed by polymerization; (2) next, the graft part₂ is formed by polymerization in the presence of the graft part₁ to obtain a two-stage graft part₁₊₂; (3) subsequently, a graft part₃ is formed by polymerization in the presence of the graft part₁₊₂ to obtain a three-stage graft part₁₊₂₊₃; and (4) after a similar process(es) is/are carried out, the graft partₙ is formed by polymerization in the presence of a graft part₁₊₂₊ . . . ₊₍ₙ₋₁₎ to obtain a multistage-polymerization graft part₁₊₂₊ . . . ₊ₙ.

In a case where the graft part is constituted by the plurality of types of graft parts, the fine polymer particles (A) may be produced as follows: the graft part which is constituted by the plurality of types of graft parts is formed by polymerization, and then these graft parts are graft polymerized to the elastic body. The fine polymer particles (A) may be produced as follows: in the presence of the elastic body, a plurality of types of polymers which constitute the graft part are formed in order by multistage graft polymerization with respect to the elastic body.

### (Method of Producing Surface-Crosslinked Polymer)

The surface-crosslinked polymer can be formed by polymerizing, by known radical polymerization in the presence of an arbitrary polymer (e.g., an elastic core), the monomer used to form the surface-crosslinked polymer. In a case where the elastic body is obtained as an aqueous latex, the surface-crosslinked polymer may be formed by emulsion polymerization.

In a case where emulsion polymerization is employed as the method of producing the fine polymer particles (A), a known emulsifying agent (dispersion agent) can be used as an emulsifying agent (dispersion agent) in the production of the fine polymer particles (A). Examples of the emulsifying agent encompass anionic emulsifying agents, nonionic emulsifying agents, polyvinyl alcohols, alkyl-substituted celluloses, polyvinylpyrrolidone, polyacrylic acid derivatives, and the like. Examples of the anionic emulsifying agent encompass sulfur-based emulsifying agents, phosphorus-based emulsifying agents, sarcosine acid-based emulsifying agents, carboxylic acid-based emulsifying agents, and the like. Examples of the sulfur-based emulsifying agent encompass sodium dodecylbenzenesulfonate (abbreviated as SDBS), and the like. Examples of the phosphorus-based emulsifying agent encompass sodium polyoxyethylene lauryl ether phosphate and the like.

In a case where emulsion polymerization is employed as the method of producing the fine polymer particles (A), a pyrolytic initiator can be used in the production of the fine polymer particles (A). It is possible to use, as the pyrolytic initiator, a known initiator such as (i) 2,2′-azobisisobutyronitrile, and (ii) peroxides such as organic peroxides and inorganic peroxides, for example. Examples of the organic peroxide encompass t-butylperoxy isopropyl carbonate, paramenthane hydroperoxide, cumene hydroperoxide, dicumyl peroxide, t-butyl hydroperoxide, di-t-butyl peroxide, and t-hexyl peroxide. Examples of the inorganic peroxide encompass hydrogen peroxide, potassium persulfate, and ammonium persulfate.

In the production of the fine polymer particles (A), a redox initiator can also be used. The redox initiator is an initiator which contains a combination of (i) a peroxide such as an organic peroxide and/or an inorganic peroxide and (ii) a reducing agent such as a transition metal salt (such as iron (II) sulfate), sodium formaldehyde sulfoxylate and/or glucose. Further, as necessary, a chelating agent such as disodium ethylenediaminetetraacetate, and/or as necessary a phosphorus-containing compound such as sodium pyrophosphate may be used in combination.

Using the redox initiator makes it possible to (i) carry out polymerization even at a low temperature at which pyrolysis of the peroxide substantially does not occur and (ii) select a polymerization temperature from a wide range of temperatures. Thus, using the redox initiator is preferable. Out of redox initiators, redox initiators in which organic peroxides such as cumene hydroperoxide, dicumyl peroxide, paramenthane hydroperoxide, and t-butyl hydroperoxide are used as peroxides are preferable. The amount of the initiator used can be within a known range. In a case where the redox initiator is used, the amounts of, for example, the reducing agent used, the transition metal salt used, and the chelating agent used can be within known ranges.

In a case where, in the formation of the elastic body, the graft part, or the surface-crosslinked polymer by polymerization, a polyfunctional monomer is used to introduce a crosslinked structure into the elastic body, the graft part, or the surface-crosslinked polymer, a known chain transfer agent can be used in an amount within a known range. By using the chain transfer agent, it is possible to easily adjust the molecular weight and/or the degree of crosslinking of the resulting elastic body, the resulting graft part, or the resulting surface-crosslinked polymer.

In the production of the fine polymer particles (A), a surfactant can be further used, in addition to the above-described components. The type and the amount of the surfactant used are set within known ranges.

In the production of the fine polymer particles (A), conditions of polymerization such as polymerization temperature, pressure, and deoxygenation can be, as appropriate, conditions within known numerical ranges.

By the above method of producing the fine polymer particles (A), it is possible to obtain an aqueous latex containing the fine polymer particles (A). That is, the description in the section <1-2. Method for producing fine polymer particles (A)> can be applied as a description of a method for preparing aqueous latex in a method for producing the present composition.

<2-3. Low Molecular Weight Compound (B) that has, in its Molecule, at Least One Polymerizable Unsaturated Bond and has Molecular Weight of Less than 1,000>

A low molecular weight compound (B) (hereinafter referred to simply as “low molecular weight compound (B)”) that has, in its molecule, at least one polymerizable unsaturated bond and has a molecular weight of less than 1,000 reduces a viscosity of the present composition and improves handleability, because the low molecular weight compound (B) has a low molecular weight. In a case where the present composition contains the matrix resin (D), the low molecular weight compound (B) is, in curing of the present composition, copolymerized with the matrix resin (D) and incorporated into a crosslinking point of a cured product.

Examples of the low molecular weight compound (B) encompass: (meth)acryloyl group-containing compounds; —COOCH═CH₂ group-containing compounds such as vinyl versatate and vinyl acetate; condensation reaction products of polyvalent carboxylic acid (such as phthalic acid, adipic acid, maleic acid, and malonic acid) and unsaturated alcohol (such as allyl alcohol); aromatic group-containing unsaturated monomers such as styrene and methylstyrene (vinyl toluene); nitrile group-containing unsaturated monomers such as acrylonitrile; and polyfunctional ester monomers such as allyl cyanurate ester.

Out of these low molecular weight compounds (B), the (meth)acryloyl group-containing compound is preferable from the viewpoint of physical properties (such as toughness and impact resistance) of the cured product. There are wide variety of (meth)acryloyl group-containing compounds. By selecting an appropriate (meth)acryloyl group-containing compound, it is possible to obtain various cured products which are excellent in intended physical properties (e.g., toughness and impact resistance). Further, the (meth)acryloyl group-containing compound has advantages of a faster radical reaction rate and availability at a relatively low cost, as compared to another low molecular weight compound (B) (i.e., a low molecular weight compound (B) other than the (meth)acryloyl group-containing compound). The inventor of one or more embodiments of the present invention has made a novel finding that, as compared to a composition containing a low molecular weight compound (B) other than the (meth)acryloyl group-containing compound, a composition containing the (meth)acryloyl group-containing compound as the low molecular weight compound (B) tends to be more easily gelatinized during storage. However, the present composition, by containing the radical scavenger (C), surprisingly has an advantage of having excellent storage stability even in a case where the present composition contains a (meth)acryloyl group-containing compound as a low molecular weight compound (B). Further, the (meth)acryloyl group-containing compound has a rate of reaction with the matrix resin (D) described later (i.e., a rate of reaction when the (meth)acryloyl group-containing compound copolymerizes with the matrix resin (D) and is incorporated into a crosslinking point of a cured product) that is close to a rate of reaction between matrix resins (D) (i.e., a curing rate between matrix resins (D)). Therefore, the (meth)acryloyl group-containing compound is easily incorporated into the crosslinking point of the matrix resin (D) when the present composition is cured in a case where the present composition contains the matrix resin (D). Therefore, the (meth)acryloyl group-containing compound has an advantage that it is easy to obtain a cured product with excellent physical properties. In the present disclosure, the term “(meth)acryloyl” refers to acryloyl and/or methacryloyl.

Specific examples of the (meth)acryloyl group-containing compound encompass methyl (meth)acrylate, ethyl (meth)acrylate, n-propyl (meth)acrylate, isopropyl (meth)acrylate, cyclohexyl (meth)acrylate, n-hexyl (meth)acrylate, n-butyl (meth)acrylate, isobutyl (meth)acrylate, t-butyl (meth)acrylate, 2-ethylhexyl (meth)acrylate, n-octyl (meth)acrylate, lauryl (meth)acrylate, allyl (meth)acrylate, phenyl (meth)acrylate, glycidyl (meth)acrylate, benzyl (meth)acrylate, α-fluoromethyl acrylate, α-chloromethyl acrylate, α-benzylmethyl acrylate, α-cyanomethyl acrylate, α-acetoxyethyl acrylate, α-phenylmethyl acrylate, α-methoxymethyl acrylate, α-n-propylmethyl acrylate, α-fluoroethyl acrylate, α-chloroethyl acrylate, chloromethyl (meth)acrylate, hydroxyethyl (meth)acrylate, 2-hydroxyethyl (meth)acrylate, 2-butoxyethyl (meth)acrylate, 2-dimethylaminoethyl (meth)acrylate, 2-diethylaminoethyl (meth)acrylate, 2-hydroxypropyl (meth)acrylate, 4-hydroxybutyl (meth)acrylate, 2-chloroethyl (meth)acrylate, 2-cyanoethyl (meth)acrylate, 2-methoxyethyl (meth)acrylate, m-chlorophenyl (meth)acrylate, p-chlorophenyl (meth)acrylate, p-tolyl (meth)acrylate, m-nitrophenyl (meth)acrylate, p-nitrophenyl (meth)acrylate, 2,2,3,3-tetrafluoropropyl (meth)acrylate, 1,1,1,3,3,3-hexafluoroisopropyl (meth)acrylate, 2,2,3,4,4,4-hexafluorobutyl (meth)acrylate, tetrahydrofurfuryl (meth)acrylate, ethylene glycol monoethyl ether acrylate, ethylene glycol di(meth)acrylate, 1,4-butanediol di(meth)acrylate, hexanediol di(meth)acrylate, diethylene glycol di(meth)acrylate, polyethylene glycol di(meth)acrylate, trimethylolpropane triacrylate and polypropyleneglycol di(meth)acrylate, isobornyl (meth)acrylate and (meth)acryloyl morpholine. These low molecular weight compounds (B) may be used alone or in combination of two or more.

Out of the (meth)acryloyl group-containing compounds, the compound having a hydroxy group is more preferable because the compound having a hydroxy group allows modification of a cured product by hybrid curing of radical crosslinking with urethane crosslinking by addition of an isocyanate compound to the present composition. Examples of the (meth)acryloyl group-containing compound having a hydroxy group encompass 2-hydroxyethyl (meth)acrylate, 2-hydroxypropyl (meth)acrylate, and 4-hydroxybutyl (meth)acrylate. Examples of the isocyanate compound added to the present composition encompass diphenylmethane diisocyanate (MDI), hexamethylene diisocyanate (HDI), toluene diisocyanate (TDI), and isophorone diisocyanate (IPDI).

The low molecular weight compound (A) may contain the (meth)acryloyl group-containing compound in an amount of not less than 10% by weight, not less than 30% by weight, not less than 50% by weight, not less than 70% by weight, or not less than 90% by weight, with respect to 100% by weight of the low molecular weight compound (A). In a case where the low molecular weight compound (A) contains a (meth)acryloyl group-containing compound within the above described range, the composition has an advantage of providing a cured product which has more excellent physical properties (such as toughness and impact resistance).

The molecular weight of the low molecular weight compound (B) may be not more than 750, less than 750, not more than 500, less than 500, not more than 300, less than 300, not more than 200, or less than 200. The low molecular weight compound (B) has an advantage that, as the molecular weight of the low molecular weight compound (B) decreases, an effect (viscosity reduction effect) of reducing the viscosity of the present composition is improved.

The low molecular weight compound (A) may contain a compound having at least one functional group X that is selected from the group consisting of an oxetane group, a hydroxy group, an epoxy group, an amino group, an imide group, a carboxylic acid group, a carboxylic anhydride group, a cyclic ester group, a cyclic amide group, a benzoxazine group, and a cyanate ester group. In a case where the low molecular weight compound (A) contains a compound having a functional group X, the composition has an advantage of providing a cured product which has excellent solvent resistance and excellent mechanical properties.

Examples of the compound having an oxetane group encompass methyl (3-ethyloxetane-3-yl)methacrylate and 3-[(allyloxy)methyl]-3-ethyloxetane.

Examples of the compound having a hydroxy group encompass hydroxyethyl (meth)acrylate, 2-hydroxyethyl (meth)acrylate, 2-hydroxypropyl (meth)acrylate, and 4-hydroxybutyl (meth)acrylate.

Examples of the compound having an epoxy group encompass glycidyl (meth)acrylate, allyl glycidyl ether, vinyl ethylene oxide, 1,2-epoxy-5-hexene, and 1,2-epoxy-9-decene.

Examples of the compound having an amino group encompass 2-dimethylaminoethyl (meth)acrylate, 2-diethylaminoethyl (meth)acrylate, and (meth)acryloyl morpholine. The “amino group” also includes a “cyclic amino group”.

Examples of the compound having an imide group encompass N-(meth)acryloxysuccinimide.

Examples of the compound having a carboxylic acid group (also called a carboxy group) encompass (meth)acrylic acid and 2-(trifluoromethyl) (meth)acrylic acid.

Examples of the compound having a carboxylic anhydride group encompass acrylic acid anhydride.

Examples of the compound having a cyclic ester encompass mevalonic lactone methacrylate.

Examples of the compound having a cyclic amide group encompass N-vinyl-2-pyrrolidone.

Examples of the compound having a benzoxazine group encompass 6-vinyl-2H-1,4-benzoxazin-3(4H)-one.

Examples of the compound having a cyanate ester group (also called a cyanate group) encompass 2-methacryloyloxyethyl isocyanate.

The compound that is contained in the low molecular weight compound (A) and has a functional group X may further have a functional group other than the functional group X, in addition to the functional group X. The low molecular weight compound (A) may include: (a) a compound that does not have the functional group X and a functional group other than the functional group X; (b) a compound that has the functional group X and does not have a functional group other than the functional group X; (c) a compound that does not have the functional group X and has a functional group other than the functional group X; (d) a compound that has the functional group X and a functional group other than the functional group X; and (e) the compounds (a) through (d) in any combination.

The low molecular weight compound (A) may contain the compound having a functional group X in an amount of not less than 10 by weight, not less than 30% by weight, not less than 50% by weight, not less than 70% by weight, or not less than 90% by weight, with respect to 100% by weight of the low molecular weight compound (A). In a case where the low molecular weight compound (A) includes the compound having a functional group X within the above described range, the composition has an advantage of providing a cured product which has more excellent solvent resistance and more excellent mechanical properties. The low molecular weight compound (A) may contain the compound having a functional group X in an amount of 100% by weight with respect to 100% by weight of the low molecular weight compound (A). That is, the low molecular weight compound (A) may consist only of the compound having a functional group X.

The low molecular weight compound (A) may contain the compound having a functional group X and the (meth)acryloyl group-containing compound in a total amount of not less than 10 by weight, not less than 30% by weight, not less than 50% by weight, not less than 70% by weight, or not less than 90% by weight, with respect to 100% by weight of the low molecular weight compound (A). In a case where the low molecular weight compound (A) contains the compound having a functional group X and the (meth)acryloyl group-containing compound in total within the above described range, the composition has an advantage of providing a cured product which has more excellent solvent resistance and more excellent mechanical properties (such as toughness and impact resistance). Note that “the compound having a functional group X and the (meth)acryloyl group-containing compound” encompass a “compound having a functional group X and a (meth)acryloyl group”.

### <2-4. Radical Scavenger (C) of Hindered Phenol Base>

A radical scavenger (C) of hindered phenol base (hereinafter also referred to simply as “radical scavenger (C)”) scavenges a radical generated during storage of the present composition, and thus makes it possible to prevent polymerization (increase in molecular weight) of the low molecular weight compound (B) and inhibit gelation and viscosity change (increase in viscosity) of the present composition. In other words, the radical scavenger (C) improves storage stability of the present composition. The radical scavenger (C) of hindered phenol base exhibits, in a mixture of the fine polymer particles (A) and the low molecular weight compound (B), a surprising effect of extremely high radical scavenging property, as compared to a radical scavenger which is not of hindered phenol base. Therefore, the present composition has, by containing the radical scavenger (C), advantages of (a) having excellent storage stability (in particular, gelation and increase in viscosity do not occur even after long-term storage at high temperature (e.g., 80° C.)) and (b) having excellent handleability when being used after storage. It can be said that the radical scavenger (C) is an antigelling agent.

Examples of the radical scavenger (C) encompass 2,6-di-t-butyl-4-dimethylaminomethylphenol (CAS registry number 88-27-7), 2,6-di-t-butyl-p-cresol (also called “butylated hydroxytoluene”, CAS registry number 128-37-0), pentaerythritol tetrakis[3-(3,5-di-t-butyl-4-hydroxyphenyl)propionate] (CAS registry number 6683-19-8), 2,4,6-tris(3′,5′-di-t-butyl-4′-hydroxybenzyl)mesitylene (CAS registry number 1709-70-2), 2,4,6-trimethylphenol (CAS registry number 527-60-6), 6-t-butyl-2,4-xylenol (CAS registry number 1879-09-0), 2,6-di-t-butyl-4-ethylphenol (CAS registry number 4130-42-1), 2,6-di-t-butyl-4-hydroxymethylphenol (CAS registry number 88-26-6), 2,4,6-tri-t-butylphenol (CAS registry number 732-26-3), 4-sec-butyl-2,6-di-t-butylphenol (CAS registry number 17540-75-9), 3-(3,5-di-t-butyl-4-hydroxyphenyl)propionic acid (CAS registry number 20170-32-5), 2,2-bis(4-hydroxy-3,5-dimethylphenyl)propane (CAS registry number 5613-46-7), methyl 3-(3,5-di-t-butyl-4-hydroxyphenyl)propionate (CAS registry number 6386-38-5), α,α′-bis(4-hydroxy-3,5-dimethylphenyl)-1,4-diisopropylbenzene (CAS registry number 36395-57-0), 2,2′,6,6′-tetra-t-butyl-4,4′-dihydroxybiphenyl (CAS registry number 128-38-1), 4,4′-methylenebis(2,6-di-t-butylphenol) (CAS registry number 118-82-1), stearyl 3-(3,5-di-t-butyl-4-hydroxyphenyl)propionate (CAS registry number 2082-79-3), 2,2′-thiodiethylene bis[3-(3,5-di-t-butyl-4-hydroxyphenyl)propionate] (CAS registry number 41484-35-9), 2,4,8,10-tetraoxaspiro[5.5]undecane-3,9-diylbis(2-methylpropane-2,1-diyl) bis[3-[3-(t-butyl)-4-hydroxy-5-methylphenyl]propanoate] (CAS registry number 90498-90-1), 1,3,5-tris(3,5-di-t-butyl-4-hydroxybenzyl)-1,3,5-triazinane-2,4,6(1H,3H,5H)-trione (CAS registry number 27676-62-6), and 2,6-di-t-butyl-4-methoxyphenol (CAS registry number 489-01-0). Those radical scavengers (C) may be used alone or in combination of two or more.

Out of the above radical scavengers (C), a radical scavenger (C) having an electron-donating group at the p-position is preferable because of having high radical scavenging property and because a resulting composition is to have further improved storage stability. Examples of the radical scavenger (C) having an electron-donating group at the p-position encompass 2,6-di-t-butyl-4-dimethylaminomethylphenol, 2,6-di-t-butyl-p-cresol, 2,4,6-trimethylphenol, 6-t-butyl-2,4-xylenol, 2,6-di-t-butyl-4-ethylphenol, 2,4,6-tri-t-butylphenol, 4-sec-butyl-2,6-di-t-butylphenol, and 2,6-di-t-butyl-4-methoxyphenol. Out of these, 2,6-di-t-butyl-4-dimethylaminomethylphenol, and 2,6-di-t-butyl-4-methoxyphenol, which have particularly high electron donating properties, are particularly preferable.

The radical scavenger (C) preferably does not have an amino group. With this feature, it is possible to prevent discoloration due to storage of the present composition.

### <2-5. Proportion of Each Component Contained in Present Composition>

In the present composition, an amount of the fine polymer particles (A) is 1% by weight to 50% by weight, and an amount of the low molecular weight compound (B) is 50% by weight to 99% by weight, where 100% by weight represents a total amount of the fine polymer particles (A) and the low molecular weight compound (B). A mixture containing the fine polymer particles (A) and the low molecular weight compound (B) at the above proportion has an appropriate viscosity and excellent handleability immediately after mixing. However, the mixture is easily gelatinized during storage and easily have increased viscosity, particularly in a case of long-term storage. However, the present composition makes it possible to maintain an appropriate viscosity after long-term storage as a result of allowing the radical scavenger (C) to be present in the mixture to inhibit gelation.

In the present composition, an amount of the fine polymer particles (A) may be 10% by weight to 50% by weight, and an amount of the low molecular weight compound (B) may be 50% by weight to 90% by weight, where 100% by weight represents a total amount of the fine polymer particles (A) and the low molecular weight compound (B). In a case where the proportions of the fine polymer particles (A) and the low molecular weight compound (B) contained in the present composition are within the above range, it is possible to bring about an advantage that the present composition can be used as a high concentration master batch.

In the present composition, it is preferable that the amount of the fine polymer particles (A) is 5% by weight to 50% by weight and the amount of the low molecular weight compound (B) is 50% by weight to 95% by weight, it is more preferable that the amount of the fine polymer particles (A) is 6% by weight to 50% by weight and the amount of the low molecular weight compound (B) is 50% by weight to 94% by weight, it is more preferable that the amount of the fine polymer particles (A) is 7% by weight to 50% by weight and the amount of the matrix resin (B) is 50% by weight to 93% by weight, it is more preferable that the amount of the fine polymer particles (A) is 8% by weight to 50% by weight and the amount of the low molecular weight compound (B) is 50% by weight to 92% by weight, it is more preferable that the amount of the fine polymer particles (A) is 9% by weight to 50% by weight and the amount of the low molecular weight compound (B) is 50% by weight to 91% by weight, it is more preferable that the amount of the fine polymer particles (A) is 10% by weight to 50% by weight and the amount of the low molecular weight compound (B) is 50% by weight to 90% by weight, it is more preferable that the amount of the fine polymer particles (A) is 15% by weight to 50% by weight and the amount of the low molecular weight compound (B) is 50% by weight to 85% by weight, it is more preferable that the amount of the fine polymer particles (A) is 20% by weight to 50% by weight and the amount of the low molecular weight compound (B) is 50% by weight to 80% by weight, it is more preferable that the amount of the fine polymer particles (A) is 25% by weight to 50% by weight and the amount of the low molecular weight compound (B) is 50% by weight to 75% by weight, it is more preferable that the amount of the fine polymer particles (A) is 30% by weight to 50% by weight and the amount of the low molecular weight compound (B) is 50% by weight to 70% by weight, it is even more preferable that the amount of the fine polymer particles (A) is 35% by weight to 50% by weight and the amount of the low molecular weight compound (B) is 50% by weight to 65% by weight, where 100% by weight represents a total amount of the fine polymer particles (A) and the low molecular weight compound (B). In the present composition, the amount of the fine polymer particles (A) may be 40% by weight to 50% by weight and the amount of the low molecular weight compound (B) may be 50% by weight to 60% by weight, and the amount of the fine polymer particles (A) may be 45% by weight to 50% by weight and the amount of the low molecular weight compound (B) may be 50% by weight to 55% by weight, where 100% by weight represents a total amount of the fine polymer particles (A) and the low molecular weight compound (B). In a case where the proportions of the fine polymer particles (A) and the low molecular weight compound (B) contained in the present composition are within the above range, it is possible to further bring about an advantage that the present composition can be used as a higher concentration master batch.

An amount of the radical scavenger (C) contained in the present composition may be not less than 0.075 parts by weight, not less than 0.125 parts by weight, not less than 0.200 parts by weight, not less than 0.250 parts by weight, not less than 0.325 parts by weight, not less than 0.375 parts by weight, not less than 0.450 parts by weight, or not less than 0.500 parts by weight, with respect to 100 parts by weight of the fine polymer particles (A). In a case where the amount of the radical scavenger (C) contained in the present composition is not less than 0.075 parts by weight, where the amount of the fine polymer particles (A) is 100 parts by weight, it is possible to bring about an advantage of further improving storage stability of the composition.

An upper limit of the amount of the radical scavenger (C) contained in the present composition is not particularly limited, and may be not more than 1.500 parts by weight, not more than 1.375 parts by weight, not more than 1.250 parts by weight, not more than 1.125 parts by weight, not more than 1.000 parts by weight, not more than 0.875 parts by weight, not more than 0.750 parts by weight, not more than 0.625 parts by weight, or not more than 0.500 parts by weight, with respect to 100 parts by weight of the fine polymer particles (A). In a case where the amount of the radical scavenger (C) contained in the present composition is not more than 1.500 parts by weight with respect to 100 parts by weight of the fine polymer particles (A), it is possible to bring about an advantage that a curing reaction of the composition is less likely to be inhibited.

### <2-6. Matrix Resin (D)>

The present composition may further contain, as necessary, a matrix resin (D) (hereinafter also referred to simply as “matrix resin (D)”) that has, in its molecule, at least two polymerizable unsaturated bonds. In a case where the present composition further contains the matrix resin (D), it is possible to bring about an advantage of improving strength and toughness of a resulting cured product. The present composition can maintain favorable handleability and storage stability, even in a case where the present composition contains the matrix resin (D). In a case where the composition contains the matrix resin (D), it can also be said that the composition is a “resin composition”.

The matrix resin (D) herein is intended to mean a resin that has, in its molecule, at least two polymerizable unsaturated bonds and has a molecular weight of not less than 1,000. There is no particular limitation to the resin which has, in its molecule, at least two polymerizable unsaturated bonds, and examples of such a resin encompass a curable resin which has a radical-polymerizable reactive group (e.g., a carbon-carbon double bond). More specifically, examples of the matrix resin (D) encompass a curable resin containing an ester bond in a repeating unit constituting the main chain, epoxy (meth)acrylate, urethane (meth)acrylate, polyether (meth)acrylate, and acrylated (meth)acrylate. These curable resins may be used alone or in combination of two or more.

Epoxy (meth)acrylate is an addition reaction product obtained by causing, in the presence of a catalyst, an addition reaction between polyepoxide (such as a bisphenol A-type epoxy resin), an unsaturated monobasic acid (such as (meth)acrylic acid), and, as necessary, a polybasic acid. The addition reaction product and a mixture obtained by mixing the addition reaction product with, as necessary, a vinyl monomer are, in general, collectively referred to as vinyl ester resins. In this production method, a small amount of polyepoxide (which is a raw material) inevitably remains. In a case where the polyepoxide does not have a polymerizable unsaturated bond in its molecule, the polyepoxide may remain without being cured and adversely affect physical properties (such as heat resistance) of a cured product. From the viewpoint of reduction of residual epoxide and the viewpoint of economy, an amount of epoxy (meth)acrylate may be less than 99 parts by weight, less than 95 parts by weight, less than 90 parts by weight, less than 80 parts by weight, less than 50 parts by weight, or less than 30 parts by weight, with respect to a total amount of 100 parts by weight of the matrix resin (D). The matrix resin (D) further preferably does not contain epoxy (meth)acrylate.

The “curable resin containing an ester bond in a repeating unit constituting the main chain” is not particularly limited, provided that the curable resin is a curable compound that has, in its molecule, an ester group and at least two polymerizable unsaturated bonds. Examples of such a curable resin encompass unsaturated polyester and polyester (meth)acrylate.

The matrix resin (D) may be at least one type of curable resin selected from the group consisting of unsaturated polyester, polyester (meth)acrylate, epoxy (meth)acrylate, urethane (meth)acrylate, polyether (meth)acrylate, and acrylated (meth)acrylate.

Out of these, from the viewpoint of economy, the matrix resin (D) may be at least one selected from the group consisting of unsaturated polyester, polyester (meth)acrylate, epoxy (meth)acrylate, and urethane (meth)acrylate. In order to reduce residual epoxide, the matrix resin (D) may be at least one selected from the group consisting of unsaturated polyester, polyester (meth)acrylate, and urethane (meth)acrylate. From the viewpoint of heat resistance, the matrix resin (D) may be unsaturated polyester or polyester (meth)acrylate. The matrix resin (D) may be polyester (meth)acrylate, from the viewpoint of high curability during radical curing, weather resistance and coloration of a resulting cured product, easy dispersion of the fine polymer particles (A), and the like. From the viewpoint of having a low viscosity and excellent workability, the matrix resin (D) may contain polyether (meth)acrylate or is polyether (meth)acrylate. From the viewpoint of having a low viscosity and excellent workability, the matrix resin (D) may contain acrylated (meth)acrylate or is acrylated (meth)acrylate.

### (Unsaturated Polyester)

The unsaturated polyester is not particularly limited, and examples thereof encompass those obtained by condensation reaction of polyhydric alcohol and unsaturated polyvalent carboxylic acid or an anhydride thereof.

Examples of the polyhydric alcohol encompass dihydric alcohols having 2 to 12 carbon atoms such as ethylene glycol, 1,2-propylene glycol, 1,3-propylene glycol, diethylene glycol, dipropylene glycol, 1,4-butanediol, and neopentyl glycol. The polyhydric alcohol may be a dihydric alcohol having 2 to 6 carbon atoms, or propylene glycol. Those dihydric alcohols may be used alone or in combination of two or more.

Examples of the unsaturated polyvalent carboxylic acid encompass divalent carboxylic acids having 3 to 12 carbon atoms, and may be divalent carboxylic acids having 4 to 8 carbon atoms. Specific examples of the divalent carboxylic acid encompass fumaric acid and maleic acid. Those divalent carboxylic acids may be used alone or in combination of two or more.

In the present composition, saturated polyvalent carboxylic acid or an anhydride thereof may be used in combination with the unsaturated polyvalent carboxylic acid or an anhydride thereof. In this case, it is preferable that an amount of unsaturated polyvalent carboxylic acid or an anhydride thereof may be not less than 30 mol %, with respect to a total amount (100 mol %) of polyvalent carboxylic acid or an anhydride thereof. Examples of the saturated polyvalent carboxylic acid or an anhydride thereof encompass phthalic anhydride, terephthalic acid, isophthalic acid, adipic acid, and glutaric acid. Those saturated polyvalent carboxylic acids or anhydrides thereof may be used alone or in combination of two or more.

The unsaturated polyester can be obtained by a condensation reaction of the polyhydric alcohol with unsaturated polyvalent carboxylic acid or an anhydride thereof or the like in the presence of an esterification catalyst such as, for example, organic titanate (such as tetrabutyl titanate) or an organotin compound (such as dibutyltin oxide).

A curable unsaturated polyester compound can also be obtained commercially from, for example, Ashland, Reichhold, and AOC.

A number average molecular weight of unsaturated polyester is not particularly limited, and may be not more than 10,000, not more than 5,000, or not more than 3,000. The lower limit of the number average molecular weight of unsaturated polyester is not particularly limited, provided that the molecular weight of unsaturated polyester is not less than 1,000.

### (Polyester (Meth)Acrylate)

Polyester (meth)acrylate is not particularly limited, and examples thereof encompass polyvalent carboxylic acids having bivalency or greater valency or anhydrides thereof, unsaturated monocarboxylic acid having a (meth)acryloyl group, and a compound obtained by esterifying, as an essential component, polyhydric alcohol having bivalency or greater valency. Polyester (meth)acrylate can be obtained, for example, by an esterification reaction of unsaturated monocarboxylic acid with a hydroxy group of polyester obtained by a condensation reaction of polyvalent carboxylic acid or an anhydride thereof with polyhydric alcohol. Alternatively, polyester (meth)acrylate can be obtained, for example, by an esterification reaction of an unsaturated glycidyl ester compound with a carboxyl group of polyester obtained by a condensation reaction of polyvalent carboxylic acid or an anhydride thereof with polyhydric alcohol.

Examples of the polyvalent carboxylic acid or an anhydride thereof encompass unsaturated carboxylic acids and anhydrides thereof such as maleic acid, maleic anhydride, fumaric acid, itaconic acid, itaconic anhydride, and citraconic acid. Moreover, examples of the polyvalent carboxylic acid or an anhydride thereof encompass saturated carboxylic acids and anhydrides thereof such as phthalic acid, phthalic anhydride, isophthalic acid, terephthalic acid, tetrahydrophthalic acid, tetrahydrophthalic anhydride, hexahydrophthalic acid, hexahydrophthalic anhydride, cyclohexanedicarboxylic acid, succinic acid, malonic acid, glutaric acid, adipic acid, azelaic acid, sebacic acid, 1,12-dodecanedioic acid, dimer acid, 2,6-naphthalenedicarboxylic acid, 2,7-naphthalenedicarboxylic acid, 2,3-naphthalenedicarboxylic acid, 2,3-naphthalenedicarboxylic anhydride, and 4,4′-biphenyldicarboxylic acid.

Out of these, the polyvalent carboxylic acid or an anhydride thereof may be maleic anhydride, fumaric acid, itaconic acid, phthalic anhydride, isophthalic acid, terephthalic acid, tetrahydrophthalic anhydride, adipic acid, or sebacic acid, or phthalic anhydride, isophthalic acid, or terephthalic acid. The isophthalic acid is particularly preferable from the viewpoint that a resulting matrix resin (D) has a low viscosity and a resulting cured product has water resistance.

Examples of the polyhydric alcohol encompass ethylene glycol, diethylene glycol, triethylene glycol, tetraethylene glycol, propylene glycol, dipropylene glycol, 1,3-butanediol, 1,4-butanediol, 1,5-pentanediol, 1,6-hexanediol, neopentyl glycol, 1,4-cyclohexanediol, 1,3-cyclohexanediol, 1,2-cyclohexanediol, 1,4-cyclohexanedimethanol, 2-methylpropane-1,3-diol, hydrogenated bisphenol A, adducts of bisphenol A and alkylene oxide (such as propylene oxide and ethylene oxide), and trimethylolpropane.

Out of these, the polyhydric alcohol may be ethylene glycol, diethylene glycol, propylene glycol, dipropylene glycol, 1,3-butanediol, 1,4-butanediol, 1,6-hexanediol, neopentyl glycol, hydrogenated bisphenol A, adducts of bisphenol A and propylene oxide, or propylene glycol, neopentyl glycol, hydrogenated bisphenol A, adducts of bisphenol A and propylene oxide. The neopentyl glycol is particularly preferable from the viewpoint that a resulting matrix resin (D) has a low viscosity and a resulting cured product has water resistance and weather resistance.

A reaction method in carrying out a condensation reaction can be a known method. A blending ratio between polyvalent carboxylic acids and polyhydric alcohols is not particularly limited. The presence or absence of the other catalyst and an additive such as a defoaming agent, and an amount thereof are also not particularly limited. Further, a reaction temperature and a reaction time in the above reaction may be set as appropriate so that the reaction is completed.

The unsaturated monocarboxylic acid is a monobasic acid having, in its molecule, at least one (meth)acryloyl group. Examples of the unsaturated monocarboxylic acid encompass acrylic acid, methacrylic acid, crotonic acid, cinnamic acid, sorbic acid, mono-2-(methacryloyloxy)ethyl malate, mono-2-(acryloyloxy)ethyl malate, mono-2-(methacryloyloxy)propyl malate, and mono-2-(acryloyloxy)propyl malate.

The unsaturated glycidyl ester compound is a glycidyl ester compound having, in its molecule, at least one (meth)acryloyl group. Examples of the unsaturated glycidyl ester compound encompass glycidyl acrylate and glycidyl methacrylate.

In the esterification reaction, it is preferable to add a polymerization inhibitor and/or molecular oxygen in order to prevent gelation by polymerization.

The polymerization inhibitor is not particularly limited, and it is possible to use a conventionally known compound. Examples of the polymerization inhibitor encompass hydroquinone, methylhydroquinone, p-t-butylcatechol, 2-t-butylhydroquinone, toluhydroquinone, p-benzoquinone, naphthoquinone, methoxyhydroquinone, phenothiazine, hydroquinone monomethyl ether, trimethylhydroquinone, methylbenzoquinone, 2,6-di-t-butyl-4-(dimethylaminomethyl)phenol, 2,5-di-t-butylhydroquinone, 4-hydroxy-2,2,6,6-tetramethylpiperidine-1-oxyl, and copper naphthenate.

As the molecular oxygen, it is possible to use, for example, air or a mixture gas of air and inert gas (such as nitrogen). In this case, it is possible to blow the molecular oxygen into the reaction system (so-called bubbling). In order to sufficiently prevent gelation by polymerization, it is preferable to use a polymerization inhibitor in combination with molecular oxygen.

Reaction conditions of the esterification reaction such as the reaction temperature and the reaction time are not particularly limited, and can be set as appropriate so that the reaction is completed. It is preferable to use the above described esterification catalyst in order to facilitate the reaction. In the esterification reaction, a solvent may be used as necessary. Specific examples of the solvent encompass, but not particularly limited to, aromatic hydrocarbons such as toluene. An amount of solvent used and a method of removing the solvent after the reaction are not particularly limited. In the esterification reaction, water is generated as a by-product. Therefore, in order to facilitate the reaction, it is preferable to remove water, which is the by-product, from the reaction system. The removal method is not particularly limited.

A number average molecular weight of polyester (meth)acrylate is not particularly limited, and may be not more than 10,000, not more than 5,000, or not more than 3,000. The lower limit of the number average molecular weight of polyester (meth)acrylate is not particularly limited, provided that the molecular weight of polyester (meth)acrylate is not less than 1,000.

### (Epoxy (Meth)Acrylate)

Epoxy (meth)acrylate is not particularly limited. For example, the epoxy (meth)acrylate can be obtained by, in the presence of an esterification catalyst, an esterification reaction of a polyfunctional epoxy compound that has, in its molecule, at least two epoxy groups, unsaturated monocarboxylic acid, and, as necessary, polyvalent carboxylic acid.

Examples of the polyfunctional epoxy compound encompass a bisphenol type epoxy compound, a novolac type epoxy compound, a hydrogenated bisphenol type epoxy compound, a hydrogenated novolac type epoxy compound, and a halogenated epoxy compound which is obtained by substituting at least one hydrogen atom of a bisphenol type epoxy compound or a novolac type epoxy compound with a halogen atom(s) (e.g., bromine atom, chlorine atom). These polyfunctional epoxy compounds may be used alone or in combination of two or more.

Examples of the bisphenol type epoxy compound encompass: glycidyl ether type epoxy compounds each obtained by a reaction of epichlorohydrin or methylepichlorohydrin with bisphenol A or bisphenol F; and epoxy compounds each obtained by a reaction of an alkylene oxide adduct of bisphenol A with epichlorohydrin or methylepichlorohydrin.

Examples of the hydrogenated bisphenol type epoxy compound encompass: glycidyl ether type epoxy compounds each obtained by a reaction of epichlorohydrin or methylepichlorohydrin with hydrogenated bisphenol A or hydrogenated bisphenol F; and epoxy compounds each obtained by a reaction of an alkylene oxide adduct of hydrogenated bisphenol A with epichlorohydrin or methylepichlorohydrin.

Examples of the novolac type epoxy compound encompass epoxy compounds each obtained by a reaction of phenol novolac or cresol novolac with epichlorohydrin or methylepichlorohydrin.

Examples of the hydrogenated novolac type epoxy compound encompass epoxy compounds each obtained by a reaction of hydrogenated phenol novolac or hydrogenated cresol novolac with epichlorohydrin or methylepichlorohydrin.

An average epoxy equivalent weight of the polyfunctional epoxy compound may fall within a range of 150 to 900, or a range of 150 to 400. Epoxy (meth)acrylate obtained using a polyfunctional epoxy compound that has an average epoxy equivalent weight of more than 900 tends to cause a decrease in reactivity and a decrease in curability of the composition. In a case where a polyfunctional epoxy compound having an average epoxy equivalent weight of less than 150 is used, physical properties of the composition are likely to be deteriorated.

The unsaturated monocarboxylic acid is a monobasic acid having, in its molecule, at least one (meth)acryloyl group. Examples of the unsaturated monocarboxylic acid encompass acrylic acid and methacrylic acid. It is possible to use compounds each obtained by replacing part of the unsaturated monocarboxylic acids with cinnamic acid, crotonic acid, sorbic acid, and half esters (such as mono-2-(methacryloyloxy)ethyl malate, mono-2-(acryloyloxy)ethyl malate, mono-2-(methacryloyloxy)propyl malate, and mono-2-(acryloyloxy)propyl malate) of unsaturated dibasic acids.

Examples of the polyvalent carboxylic acid encompass maleic acid, maleic anhydride, fumaric acid, itaconic acid, itaconic anhydride, citraconic acid, adipic acid, azelaic acid, phthalic acid, phthalic anhydride, isophthalic acid, terephthalic acid, trimellitic anhydride, hexahydrophthalic anhydride, 1,6-cyclohexanedicarboxylic acid, dodecanedioic acid, and dimer acid. A ratio of (i) unsaturated monocarboxylic acid and polyvalent carboxylic acid which is used as necessary and (ii) the polyfunctional epoxy compound may be set so that a ratio of (i) a total amount of carboxyl groups in the unsaturated monocarboxylic acid and the polyvalent carboxylic acid and (ii) an epoxy group of the polyfunctional epoxy compound falls within a range of 1:1.2 to 1.2:1.

As the esterification catalyst, it is possible to use a conventionally known compound. Specific examples of such a compound encompass: tertiary amines such as triethylamine, N,N-dimethylbenzylamine, and N,N-dimethylaniline; quaternary ammonium salts such as trimethylbenzylammonium chloride and pyridinium chloride; phosphonium compounds such as triphenylphosphine, tetraphenylphosphonium chloride, tetraphenylphosphonium bromide, tetraphenylphosphonium iodide; sulfonic acids such as p-toluenesulfonic acid; and organometallic salts such as zinc octenoate.

The reaction method and the reaction conditions in carrying out the above reaction are not limited to any particular ones. In the esterification reaction, it is more preferable to add a polymerization inhibitor and/or molecular oxygen to the reaction system in order to prevent gelation by polymerization. As the polymerization inhibitor and the molecular oxygen, ones listed in the section of polyester (meth)acrylate above can be similarly used.

A number average molecular weight of epoxy (meth)acrylate is not particularly limited, and may be not more than 10,000, not more than 5,000, or not more than 2,500. The lower limit of the number average molecular weight of epoxy (meth)acrylate is not particularly limited, provided that the molecular weight of epoxy (meth)acrylate is not less than 1,000.

### (Urethane (Meth)Acrylate)

Urethane (meth)acrylate is not particularly limited, and examples thereof encompass those obtained by a urethanization reaction of a polyisocyanate compound, a polyol compound, and a hydroxy group-containing (meth)acrylate compound. Examples of the urethane (meth)acrylate further encompass those obtained by a urethanization reaction between a polyol compound and a (meth)acryloyl group-containing isocyanate compound, and those obtained by a urethanization reaction between a hydroxy group-containing (meth)acrylate compound and a polyisocyanate compound.

Specific examples of the polyisocyanate compound encompass 2,4-tolylene diisocyanate and a hydride thereof, an isomer of 2,4-tolylene diisocyanate and a hydride thereof, diphenylmethane diisocyanate, hydrogenated diphenylmethane diisocyanate, hexamethylene diisocyanate, a trimer of hexamethylene diisocyanate, isophorone diisocyanate, xylene diisocyanate, hydrogenated xylene diisocyanate, dicyclohexylmethane diisocyanate, tolidine diisocyanate, naphthalene diisocyanate, triphenylmethane triisocyanate, Millionate MR, Coronate L (manufactured by Nippon Polyurethane Industry Co., Ltd.), BURNOCK D-750, CRISVON NX (manufactured by Dainippon Ink and Chemicals Inc.), Desmodur L (manufactured by Sumitomo Bayer), and TAKENATE D102 (manufactured by Takeda Pharmaceutical Company Limited).

Examples of the polyol compound encompass polyether polyol, polyester polyol, polybutadiene polyol, and adducts of bisphenol A and alkylene oxide (such as propylene oxide or ethylene oxide).

Specific examples of the polyether polyol encompass polyoxyethylene glycol, polyoxypropylene glycol, polytetramethylene glycol, and polyoxymethylene glycol. A number average molecular weight of the polyether polyol is not particularly limited, and may be not more than 5,000, or not more than 3,000. The lower limit of the number average molecular weight of polyether polyol is not particularly limited, provided that the molecular weight of polyether polyol is not less than 1,000.

A number average molecular weight of polyester polyol is not particularly limited, and may be not more than 5,000, or not more than 3,000. The lower limit of the number average molecular weight of polyester polyol is not particularly limited, provided that the molecular weight of polyester polyol is not less than 1,000.

The hydroxy group-containing (meth)acrylate compound is a (meth)acrylate compound having, in its molecule, at least one hydroxy group. Examples of the hydroxy group-containing (meth)acrylate compound encompass 2-hydroxyethyl (meth)acrylate, 2-hydroxypropyl (meth)acrylate, 3-hydroxybutyl (meth)acrylate, polyethylene glycol mono(meth)acrylate, and polypropylene glycol mono(meth)acrylate.

The (meth)acryloyl group-containing isocyanate compound is a compound of type that contains, in its molecule, both at least one (meth)acryloyl group and an isocyanate group. Examples of the (meth)acryloyl group-containing isocyanate compound encompass 2-(meth)acryloyloxymethyl isocyanate, 2-(meth)acryloyloxyethyl isocyanate, and a compound obtained by a urethanization reaction between a hydroxy group-containing (meth)acrylate compound and polyisocyanate at a molar ratio of 1:1.

A reaction method of the urethanization reaction is not limited to any particular one, and reaction conditions such as a reaction temperature and a reaction time are not limited to any particular ones, and can be set as appropriate so that the reaction is completed. For example, in a case where the polyisocyanate compound, the polyol compound, and the hydroxy group-containing (meth)acrylate compound are subjected to a urethanization reaction, the following operations may be carried out. First, the polyisocyanate compound and the polyol compound are subjected to a urethanization reaction so that a ratio (isocyanate group/hydroxy group) of an isocyanate group of the polyisocyanate compound and a hydroxy group of the polyol compound falls within a range of 3.0 to 2.0 to generate a prepolymer having an isocyanate group at its terminal. Next, the hydroxy group-containing (meth)acrylate and the prepolymer are then subjected to a urethanization reaction so that a weight of a hydroxy group of the hydroxy group-containing (meth)acrylate and a weight of an isocyanate group of the prepolymer are substantially equivalent to each other.

In the above reaction, it is preferable to use a urethanization catalyst to facilitate the urethanization reaction. Examples of the urethanization catalyst encompass tertiary amines such as triethylamine and metal salts such as di-n-butyltin dilaurate. Any of general urethanization catalysts can be used. In the reaction, it is preferable to add a polymerization inhibitor and/or molecular oxygen in order to prevent gelation by polymerization. As the polymerization inhibitor and the molecular oxygen, ones listed in the section of polyester (meth)acrylate above can be similarly used.

A number average molecular weight of urethane (meth)acrylate is not particularly limited, and may be not more than 10,000, not more than 8,000, or not more than 5,000. The lower limit of the number average molecular weight of urethane (meth)acrylate is not particularly limited, provided that the molecular weight of urethane (meth)acrylate is not less than 1,000.

### (Polyether (Meth)Acrylate)

Polyether (meth)acrylate is not particularly limited. Examples of the polyether (meth)acrylate encompass those obtained by an esterification reaction of polyether polyol with (meth)acrylic acid. It is possible to discretionarily use one which is obtained with another known technique.

A number average molecular weight of the polyether polyol may be within a range of 100 to 5,000, or within a range of 100 to 3,000. Specific examples of the polyether polyol encompass polyoxyethylene glycol, polyoxypropylene glycol, polytetramethylene glycol, and polyoxymethylene glycol.

A number average molecular weight of polyether (meth)acrylate is not particularly limited, and may be not more than 5,000, or not more than 3,000. The lower limit of the number average molecular weight of polyether (meth)acrylate is not particularly limited, provided that the molecular weight of polyether (meth)acrylate is not less than 1,000.

### (Acrylated (Meth)Acrylate)

Acrylated (meth)acrylate is not particularly limited. Examples of the acrylated (meth)acrylate encompass those obtained by a reaction between (meth)acrylic acid and an epoxy group-containing acrylic resin having, in its molecule, at least two epoxy groups. It is possible to discretionarily use one which is obtained with another known technique.

A number average molecular weight of acrylated (meth)acrylate is not particularly limited, and may be not more than 5,000, or not more than 3,000. The lower limit of the number average molecular weight of acrylated (meth)acrylate is not particularly limited, provided that the molecular weight of acrylated (meth)acrylate is not less than 1,000.

### (Physical Properties of Matrix Resin (D))

The matrix resin (D) is not particularly limited in terms of the properties thereof. The matrix resin (D) may have a viscosity of 100 mPa·s to 1,000,000 mPa·s at 25° C. The viscosity of the matrix resin (D) may be not more than 50,000 mPa·s, not more than 30,000 mPa·s, or not more than 15,000 mPa·s, at 25° C. According to the above feature, the matrix resin (D) has an advantage of having excellent flowability. It can also be said that the matrix resin (D) having a viscosity of 100 mPa·s to 1,000,000 mPa·s at 25° C. is a liquid.

Further, the viscosity of the matrix resin (D) may be not less than 100 mPa·s, not less than 500 mPa·s, not less than 1,000 mPa·s, or not less than 1,500 mPa·s at 25° C., because such a viscosity allows the matrix resin (D) to get between the fine polymer particles (A) and thereby allows prevention of fusion between the fine polymer particles (A).

The matrix resin (D) may have a viscosity of more than 1,000,000 mPa·s. The matrix resin (D) may be a semisolid (semiliquid) or may be alternatively a solid. In a case where the matrix resin (D) has a viscosity of more than 1,000,000 mPa·s, a resulting composition has advantages that the composition is less sticky and easy to handle.

The matrix resin (D) may have an endothermic peak at not higher than 25° C., or not higher than 0° C., in its differential scanning calorimetry (DSC) thermogram. According to the above feature, the matrix resin (D) has an advantage of having excellent flowability.

### (Amount of Matrix Resin (D) Contained in Present Composition)

An amount of the matrix resin (D) contained in the present composition may be not less than 10 parts by weight, not less than 20 parts by weight, not less than 30 parts by weight, not less than 50 parts by weight, or not less than 70 parts by weight, where 100 parts by weight represents a total amount of the fine polymer particles (A) and the low molecular weight compound (B). In a case where the amount of the matrix resin (D) contained in the present composition is within the above range, it is possible to bring about an advantage that a resulting cured product has improved strength and toughness.

An upper limit of the amount of the matrix resin (D) contained in the present composition is not particularly limited. From the viewpoint of imparting excellent handleability and storage stability to the present composition, the upper limit of the amount of the matrix resin (D) contained in the present composition may be not more than 10,000 parts by weight, not more than 5,000 parts by weight, not more than 2,000 parts by weight, not more than 1,000 parts by weight, not more than 750 parts by weight, not more than 500 parts by weight, not more than 300 parts by weight, not more than 100 parts by weight, not more than 90 parts by weight, not more than 80 parts by weight, or not more than 70 parts by weight, where 100 parts by weight represents a total amount of the fine polymer particles (A) and the low molecular weight compound (B).

### <2-7. Other Components>

The present composition may further contain, as necessary, for example: a coloring agent such as a pigment and a colorant; an extender; an ultraviolet ray absorbing agent; an antioxidant; a stabilizer (antigelling agent); a plasticizing agent; a leveling agent; a defoaming agent; a silane coupling agent; an antistatic agent; a flame retardant; a lubricant; a thickener; a viscosity reducer; a shrinkage reducing agent; a fiber-reinforced material; inorganic filler; organic filler; an internal mold release; a wetting agent; a polymerization adjusting agent; a thermoplastic resin; a desiccant; a dispersion agent; a radical polymerization initiator; a curing accelerator; and/or a promoter. Amounts of those other components used (amounts contained in the present composition) can be set as appropriate by a person skilled in the art in accordance with an intended purpose.

### 3. Method for Producing Composition

The present composition is a composition in which the fine polymer particles (A) are dispersed (preferably in the form of primary particles) in the low molecular weight compound (B) in the presence of the radical scavenger (C). As a method of obtaining the present composition, it is possible to use any known method of obtaining a composition in which the fine polymer particles (A) are dispersed (preferably in the form of primary particles) in the low molecular weight compound (B). Examples of such a method encompass: a method in which the fine polymer particles (A) obtained as an aqueous latex are brought into contact with the low molecular weight compound (B) and then unnecessary components such as water are removed; and a method in which the fine polymer particles (A) are extracted once in an organic solvent, then mixed with the low molecular weight compound (B), and then the organic solvent is removed. The method described in International Publication No. WO 2005/28546 may be used as a method of producing the present composition.

A method for producing a composition in accordance with one or more embodiments of the present invention may be configured to include: a first step of mixing an aqueous latex containing fine polymer particles (A) with an organic solvent that exhibits partial solubility in water, and then bringing a resulting mixture into contact with water to generate, in an aqueous phase, an agglutinate of the fine polymer particles (A), the agglutinate containing the organic solvent; a second step of separating and collecting the agglutinate from the aqueous phase, and then mixing the agglutinate with the organic solvent to obtain a first organic solvent dispersion slurry containing the fine polymer particles (A); a third step of mixing the first organic solvent dispersion slurry, a low molecular weight compound (B) that has, in its molecule, at least one polymerizable unsaturated bond and that has a molecular weight of less than 1,000, and a radical scavenger (C) of hindered phenol base to obtain a second organic solvent dispersion slurry containing the fine polymer particles (A), the low molecular weight compound (B), and the radical scavenger (C); and a fourth step of distilling off the organic solvent from the second organic solvent dispersion slurry, the first step, the second step, the third step, and the fourth step being carried out in this order, the fine polymer particles (A) containing a rubber-containing graft copolymer that includes an elastic body and a graft part grafted to the elastic body, the elastic body containing at least one selected from the group consisting of diene-based rubbers, (meth)acrylate-based rubbers, and organosiloxane-based rubbers, and in the third step, the fine polymer particles (A) and the low molecular weight compound (B) being mixed at a blending ratio in which an amount of the fine polymer particles (A) is 1% by weight to 50% by weight and an amount of the low molecular weight compound (B) is 50% by weight to 99% by weight, where 100% by weight represents a total amount of the fine polymer particles (A) and the low molecular weight compound (B).

A “method for producing a composition in accordance with one or more embodiments of the present invention” herein is also referred to simply as a “present production method”. The “mixture obtained by mixing an aqueous latex containing fine polymer particles (A) with an organic solvent that exhibits partial solubility in water” may be referred to as a “mixture X”.

The following will describe the present production method. Except for matters described in detail below, the description in [2. Composition] is cited as appropriate.

The present production method can provide a composition having excellent storage stability, because the present production method has the above feature. The present production method can provide a composition having also excellent handleability, because the present production method has the above feature.

The method for producing a composition in accordance with one or more embodiments of the present invention can be suitably used to produce the composition described in the section [2. Composition]. Therefore, the descriptions in the section [2. Composition] can be appropriately cited as descriptions of fine polymer particles (A), a low molecular weight compound (B), and a radical scavenger (C), as well as a matrix resin (D) added as necessary, which are used in the method for producing a composition in accordance with one or more embodiments of the present invention.

As the “aqueous latex containing the fine polymer particles (A)”, it is possible to use an aqueous latex containing fine polymer particles (A) produced by the foregoing method for producing fine polymer particles (A). The fine polymer particles (A) may be produced by emulsion polymerization and obtained as an aqueous latex.

The “organic solvent that exhibits partial solubility in water” can be used without limitation, provided that the organic solvent is one or more types of organic solvents or an organic solvent mixture in which, when the aqueous latex of the fine polymer particles (A) is mixed with the organic solvent, mixing can be achieved without substantial precipitation by coagulation of the fine polymer particles (A). Solubility of the organic solvent in water at 20° C. may be not less than 5% by weight and not more than 40% by weight, or not less than 5% by weight and not more than 30% by weight. In a case where the organic solvent which exhibits partial solubility in water has solubility of not more than 40% by weight in water at 20° C., the aqueous latex of the polymer particles (A) can be smoothly mixed without coagulation. In a case where the organic solvent which exhibits partial solubility in water has solubility of not less than 5% by weight in water at 20° C., the organic solvent can be sufficiently mixed with the aqueous latex of the polymer particles (A), and thus mixing operation can be smoothly carried out.

Specific examples of the “organic solvent that exhibits partial solubility in water” encompass one or more organic solvents which (i) are selected from or are mixtures of: esters such as methyl acetate, ethyl acetate, propyl acetate, and butyl acetate; ketones such as acetone, methyl ethyl ketone, diethyl ketone, and methyl isobutyl ketone; alcohols such as ethanol, (iso)propanol, and butanol; ethers such as tetrahydrofuran, tetrahydropyran, dioxane, and diethyl ether; aromatic hydrocarbons such as benzene, toluene, and xylene; and halogenated hydrocarbons such as methylene chloride and chloroform and (ii) have a solubility which satisfies the above described range in water at 20° C. Out of these, from the viewpoint of affinity to a polymerizable organic compound having reactivity and availability, as the organic solvent that exhibits partial solubility in water, an organic solvent (mixture) containing methyl ethyl ketone in an amount of not less than 50% by weight may be used, and an organic solvent (mixture) containing methyl ethyl ketone in an amount of not less than 75% by weight may be used.

An amount of the organic solvent that exhibits partial solubility in water used in the first step is not particularly limited, and may be set as appropriate depending on a type of fine polymer particles (A), a concentration of fine polymer particles (A) in an aqueous latex containing the fine polymer particles (A), and the like. An amount of the organic solvent that exhibits partial solubility in water used in the first step may be, for example, 50 parts by weight to 400 parts by weight, or 70 parts by weight to 300 parts by weight, with respect to 100 parts by weight of the aqueous latex containing the fine polymer particles (A).

No special device or method is necessary in a mixing operation during mixing of the aqueous latex containing the fine polymer particles (A) with the organic solvent that exhibits partial solubility in water. In the mixing operation, a known device or method can be used as appropriate, provided that a favorable mixed state can be achieved with use of the device or method. Examples of a general device encompass a mixing vessel equipped with a stirrer blade.

In the first step, a mixture X is obtained by mixing the aqueous latex containing the fine polymer particles (A) with the organic solvent that exhibits partial solubility in water. In the first step, the mixture X is further brought into contact with water. By such contact, part of the organic solvent contained in the mixture X is dissolved in water, and thus an aqueous phase can be generated. At the same time, water derived from the aqueous latex contained in the mixture X can also be released into the aqueous phase. For this reason, in a mixture obtained by contact of the mixture X with water, the fine polymer particles (A) are concentrated in the organic solvent containing a small amount of water, and as a result, an agglutinate of the fine polymer particles (A) is generated in the aqueous phase. That is, the agglutinate of the fine polymer particles (A) obtained in the first step can contain the organic solvent and may contain a small amount of water.

In the first step, an amount of water used to contact with the mixture X is not particularly limited, and may be set as appropriate depending on a type of fine polymer particles (A), a concentration of the fine polymer particles (A) in the aqueous latex containing the fine polymer particles (A), a type of the organic solvent that exhibits partial solubility in water, an amount of the organic solvent that exhibits partial solubility in water, and the like. The amount of water used to contact with the mixture X may be, for example, 40 parts by weight to 350 parts by weight, or 60 parts by weight to 250 parts by weight, with respect to 100 parts by weight of the organic solvent that exhibits partial solubility in water.

In the first step, from the viewpoint of preventing partial formation of a non-agglutinate, contact between the mixture X and water may be carried out under stirring or in a flowing state where flowability equivalent to that of stirring can be provided. In the first step, it is more preferable that: mixing of the aqueous latex containing the fine polymer particles (A) and the organic solvent that exhibits partial solubility in water is carried out with a device having a stirring function (e.g., a mixing vessel equipped with a stirrer blade); and then water is added to a mixture X obtained in the device, and contact between the mixture X and water is carried out in the device.

In the second step, by separating the agglutinate from the aqueous phase, it is possible to remove the water contained in the organic solvent which can be entrained with the agglutinate. Such water can contain an emulsifying agent and an electrolyte derived from the production process of the aqueous latex of the fine polymer particles (A). Therefore, by separating the agglutinate from the aqueous phase, the emulsifying agent and electrolyte derived from the production process of the aqueous latex of the fine polymer particles (A) which are contained in the agglutinate can be separated and removed from the fine polymer particles (A) together with the aqueous phase.

In the second step, a device used to separate and collect the agglutinate from the aqueous phase, and a method for separating and collecting the agglutinate from the aqueous phase are not limited to any particular ones, and known device and method can be used as appropriate. The agglutinate has good separability from the aqueous phase. Specific aspects of separating and collecting the agglutinate from the aqueous phase encompass a filtration operation in which a filter paper, a filter cloth, or a metal screen having relatively rough meshes is used.

In the second step, the following operations may be repeated in order to obtain an agglutinate of the fine polymer particles (A) that has fewer impurities such as an emulsifying agent and an electrolyte: (1) an agglutinate is separated and collected, and then water is added to the obtained agglutinate to obtain a mixture of the agglutinate and water; and (2) the agglutinate is separated and collected from the obtained mixture.

In the second step, the agglutinate separated and collected from the aqueous phase is mixed with an organic solvent. By such an operation, it is possible to obtain a first organic solvent dispersion slurry in which the fine polymer particles (A) are dispersed (preferably substantially in the form of primary particles) in the organic solvent.

In the second step, an amount of the organic solvent mixed with the agglutinate is not limited to any particular one, and may be set as appropriate depending on a type of the fine polymer particles (A), a type of the organic solvent used, and the like. The amount of the organic solvent mixed with the agglutinate may be, for example, 40 parts by weigh to 1,400 parts by weight, or 200 parts by weigh to 1,000 parts by weight, with respect to 100 parts by weight of the fine polymer particles (A).

As the organic solvent mixed with the agglutinate, aliphatic hydrocarbons such as hexane, heptane, octane, cyclohexane, and ethylcyclohexane, as well as mixtures thereof, can be used, in addition to the above-described organic solvents that each exhibits partial solubility in water. From the viewpoint of more reliable dispersibility of the fine polymer particles (A) in the agglutinate, it is preferable to use, as an organic solvent to be mixed with the agglutinate, an organic solvent which is identical in type to the organic solvent that exhibits partial solubility in water used in the first step.

In the second step, a device used in the mixing operation of the agglutinate with the organic solvent is not particularly limited, and a method of the mixing operation is not particularly limited. In the second step, mixing of the agglutinate with the organic solvent can be carried out with a device having general stirring and mixing functions (e.g., a mixing vessel equipped with a stirrer blade).

The inventor of one or more embodiments of the present invention has uniquely made the following findings: In a case where an organic solvent is distilled off from a mixture that contains the first organic solvent dispersion slurry (i.e., a dispersion slurry containing the fine polymer particles (A) and the organic solvent) and the low molecular weight compound (B) and that does not contain a radical scavenger (C), surprisingly, a resulting composition has a remarkably high viscosity or a gelatinized composition is obtained. Although it is not clear why the resulting composition has a remarkably high viscosity or the gelatinized composition is obtained, the inventor of one or more embodiments of the present invention has inferred the reason as in (i) through (iv) below: (i) while an organic solvent is distilled off from a mixture that contains the first organic solvent dispersion slurry and the low molecular weight compound (B) and that does not contain a radical scavenger (C), a radical is generated from the mixture; (ii) the low molecular weight compound (B) is polymerized (i.e., the molecular weight increases) by the radical generated from the mixture, and thereby a resulting composition has a remarkably high viscosity or a gelatinized composition is obtained; (iii) in a case where a temperature of the mixture is increased for distilling off the organic solvent from the mixture, in particular, a large amount of radicals can be generated from the mixture; and (iv) in a case where oxygen is removed from an environment surrounding the mixture for distilling off the organic solvent from the mixture, polymerization of the low molecular weight compound (B) can be remarkably facilitated because, in particular, the radicals are not deactivated.

As a result of diligent study based on the above findings, the inventor of one or more embodiments of the present invention has further made the following findings (i) and (ii): (i) by adding a radical scavenger (in particular, the radical scavenger (C) of hindered phenol base) to a mixture containing the first organic solvent dispersion slurry and the low molecular weight compound (B), it is possible to inhibit polymerization (increase in molecular weight) of the low molecular weight compound (B) in the fourth step; and (ii) as a result, a resulting composition is not gelatinized, does not have an increased viscosity, and has excellent handleability.

Therefore, the present production method includes the third step of mixing the first organic solvent dispersion slurry, the low molecular weight compound (B) that has, in its molecule, at least one polymerizable unsaturated bond and has a molecular weight of less than 1,000, and the radical scavenger (C) of hindered phenol base. By such an operation, it is possible to obtain a second organic solvent dispersion slurry containing the fine polymer particles (A), the low molecular weight compound (B), and the radical scavenger (C) of hindered phenol base. In one or more embodiments of the present invention, the fine polymer particles (A) are dispersed substantially in the form of primary particles in the organic solvent in the second organic solvent dispersion slurry.

In the third step, an amount of the low molecular weight compound (B) to be mixed with the first organic solvent dispersion slurry can be set depending on an amount (concentration) of the fine polymer particles (A) in the first organic solvent dispersion slurry. More specifically, in the third step, the fine polymer particles (A) and the low molecular weight compound (B) are mixed at a blending ratio in which an amount of the fine polymer particles (A) is 1% by weight to 50% by weight, and an amount of the low molecular weight compound (B) is 50% by weight to 99% by weight, where 100% by weight represents a total amount of the fine polymer particles (A) and the low molecular weight compound (B).

In the third step, an amount of the radical scavenger (C) to be mixed with the first organic solvent dispersion slurry is not particularly limited, and may be set as appropriate depending on the amount (concentration) of the fine polymer particles (A) in the first organic solvent dispersion slurry and the amount of the low molecular weight compound (B) used in the third step. An amount of the radical scavenger (C) to be mixed with the first organic solvent dispersion slurry is set so that the amount of the radical scavenger (C) with respect to 100 parts by weight of the fine polymer particles (A) in the ultimately obtained composition may be not less than 0.075 parts by weight, not less than 0.125 parts by weight, not less than 0.200 parts by weight, not less than 0.250 parts by weight, not less than 0.325 parts by weight, not less than 0.375 parts by weight, not less than 0.450 parts by weight, or not less than 0.500 parts by weight. The amount of the radical scavenger (C) to be mixed with the first organic solvent dispersion slurry is set so that the amount of the radical scavenger (C) with respect to 100 parts by weight of the fine polymer particles (A) in the ultimately obtained composition may be not more than 1.500 parts by weight, not more than 1.375 parts by weight, not more than 1.250 parts by weight, not more than 1.125 parts by weight, not more than 1.000 parts by weight, not more than 0.875 parts by weight, not more than 0.750 parts by weight, not more than 0.625 parts by weight, or not more than 0.500 parts by weight.

In the third step, a device used in a mixing operation of mixing the first organic solvent dispersion slurry, the low molecular weight compound (B), and the radical scavenger (C), a method of the mixing operation, and the order in which these components are mixed are not particularly limited. In the third step, mixing of the first organic solvent dispersion slurry, the low molecular weight compound (B), and the radical scavenger (C) can be carried out with a device having general stirring and mixing functions (e.g., a mixing vessel equipped with a stirrer blade).

The order of mixing the first organic solvent dispersion slurry, the low molecular weight compound (B), and the radical scavenger (C) is not particularly limited. The order may be as follows: (i) the first organic solvent dispersion slurry and the low molecular weight compound (B) are mixed, and then a resulting mixture and the radical scavenger (C) are mixed; (ii) the first organic solvent dispersion slurry and the radical scavenger (C) are mixed, and then a resulting mixture and the low molecular weight compound (B) are mixed; or (iii) the first organic solvent dispersion slurry, the low molecular weight compound (B), and the radical scavenger (C) are simultaneously mixed together.

In the fourth step, the organic solvent is distilled off from the second organic solvent dispersion slurry. By such an operation (in other words, by the present production method), it is possible to obtain a composition which contains the fine polymer particles (A), the low molecular weight compound (B), and the radical scavenger (C), and in which an amount of the fine polymer particles (A) is 1% by weight to 50% by weight, and an amount of the low molecular weight compound (B) is 50% by weight to 99% by weight, where 100% by weight represents a total amount of the fine polymer particles (A) and the low molecular weight compound (B). In one or more embodiments of the present invention, the fine polymer particles (A) are dispersed substantially in the form of primary particles in the low molecular weight compound (B) in the composition.

In the fourth step, a device used to distill off the organic solvent from the second organic solvent dispersion slurry, and a method to distill off the organic solvent from the second organic solvent dispersion slurry are not limited to any particular ones, and a known device and a known method can be used. Specific aspects of distilling off the organic solvent from the second organic solvent dispersion slurry encompass: (a) a method in which the mixture is introduced into the vessel, and the organic solvent is distilled off with heat under reduced pressure; (b) a method in which a dry gas and the mixture are subjected to countercurrent contact in the vessel; a continuous method in which a thin-film evaporator is used; and a method in which an extruder or a continuous stirrer vessel each of which is equipped with a devolatilizing mechanism is used.

In a case of producing the present composition further containing the matrix resin (D), in the above fourth step, the second organic solvent dispersion slurry may be mixed with the matrix resin (D), and then the organic solvent may be distilled off from a resulting mixture. This makes it possible to obtain a composition in which the fine polymer particles (A) are dispersed in the form of primary particles in the low molecular weight compound (B) and the matrix resin (D) in the presence of the radical scavenger (C).

In the above step, it is preferable that the mixture of the low molecular weight compound (B) and the matrix resin (D) is in the form of liquid at 23° C., because the mixture in such a form can be easily mixed with the second organic solvent dispersion slurry. Further, it is more preferable that the matrix resin (D) alone is in the form of liquid at 23° C. The “form of liquid at 23° C.” means that the softening point is not higher than 23° C., and means that flowability is exhibited at 23° C.

### 4. Cured Product

In a case where the present composition contains the matrix resin (D), in a cured product obtained by curing the present composition, in other words, in a cured product which is formed by curing the present composition, the fine polymer particles (A) can be uniformly dispersed in the form of primary particles. The cured product obtained by curing the present composition is also one or more embodiments of the present invention.

### 5. Applications

The present composition can be used in various applications, and the applications are not limited to any particular ones. The composition may be used in applications such as, for example, adhesive agents, coating materials, binders for reinforcement fibers, composite materials, molding materials for 3D printers, sealants, electronic substrates, ink binders, wood chip binders, binders for rubber chips, foam chip binders, binders for castings, rock mass consolidation materials for floor materials and ceramics, and urethane foams. Examples of the urethane foams encompass automotive seats, automotive interior parts, sound absorbing materials, damping materials, shock absorbers (shock absorbing materials), heat insulating materials, and floor material cushions for construction. The present composition may be used for, out of the above applications, materials of adhesive agents, coating materials, binders for reinforcement fibers, composite materials, molding materials for 3D printers, sealants, electronic substrates, and the like. Out of these, the present composition can be suitably used as a molding material for a 3D printer, because of the advantage of obtainment of a cured product which has high toughness. That is, in one or more embodiments of the present invention, a composition for a 3D printer (for 3D printing) containing the present composition is provided. In a case where the present composition is used as a composition for a 3D printer: the present composition may be used alone as a composition for a 3D printer; a combination of the present composition and a matrix resin (D) may be used as a composition for a 3D printer; or a combination of the present composition and another low molecular weight compound (a low molecular weight compound other than the low molecular weight compound (B)), another matrix resin (a matrix resin other than the matrix resin (D)), and other components may be used as a composition for a 3D printer.

<1> A composition containing: fine polymer particles (A); a low molecular weight compound (B) that has, in its molecule, at least one polymerizable unsaturated bond and has a molecular weight of less than 1,000; and a radical scavenger (C) of hindered phenol base, the fine polymer particles (A) containing a rubber-containing graft copolymer that includes an elastic body and a graft part grafted to the elastic body, the elastic body containing at least one selected from the group consisting of diene-based rubbers, (meth)acrylate-based rubbers, and organosiloxane-based rubbers, and an amount of the fine polymer particles (A) being 1% by weight to 50% by weight and an amount of the low molecular weight compound (B) being 50% by weight to 99% by weight, where 100% by weight represents a total amount of the fine polymer particles (A) and the low molecular weight compound (B).

<2> The composition described in <1>, in which: the molecular weight of the low molecular weight compound (B) is less than 750.

<3> The composition described in <1> or <2>, in which: the radical scavenger (C) contains no amino group.

<4> The composition described in any one of <1> through <3>, in which: an amount of the radical scavenger (C) contained in the composition is not less than 0.075 parts by weight, with respect to 100 parts by weight of the fine polymer particles (A).

<5> The composition described in any one of <1> through <4>, in which: the amount of the fine polymer particles (A) contained in the composition is 10% by weight to 50% by weight, and the amount of the low molecular weight compound (B) contained in the composition is 50% by weight to 90% by weight, where 100% by weight represents a total amount of the fine polymer particles (A) and the low molecular weight compound (B).

<6> The composition described in any one of <1> through <5>, in which: the elastic body contains (i) an elastic core of the elastic body, the elastic core being obtained by polymerizing at least one type of monomer, the elastic core being selected from the group consisting of diene-based rubbers, (meth)acrylate-based rubbers, and organosiloxane-based rubbers and (ii) a surface-crosslinked polymer which is obtained by polymerizing at least one type of monomer selected from the group consisting of a polyfunctional monomer that has, in its molecule, at least two polymerizable unsaturated bonds and a vinyl-based monomer other than the polyfunctional monomer.

<7> The composition described in any one of <1> through <6>, in which: the low molecular weight compound (B) is a (meth)acryloyl group-containing compound.

<8> The composition described in any one of <1> through <7>, in which: the low molecular weight compound (B) contains a compound having at least one functional group X that is selected from the group consisting of an oxetane group, a hydroxy group, an epoxy group, an amino group, an imide group, a carboxylic acid group, a carboxylic anhydride group, a cyclic ester group, a cyclic amide group, a benzoxazine group, and a cyanate ester group; and the graft part contains no functional group Y that is reactive with the functional group X.

<9> The composition described in any one of <1> through <8>, further containing: a matrix resin (D) that has, in its molecule, at least two polymerizable unsaturated bonds.

<10> The composition described in <9>, in which: the matrix resin (D) is at least one type of curable resin selected from the group consisting of unsaturated polyester, polyester (meth)acrylate, epoxy (meth)acrylate, urethane (meth)acrylate, polyether (meth)acrylate, and acrylated (meth)acrylate.

<11> A composition for a 3D printer, the composition containing a composition described in any one of <1> through <10>.

<12> A method for producing a composition, the method including: a first step of mixing an aqueous latex containing fine polymer particles (A) with an organic solvent that exhibits partial solubility in water, and then bringing a resulting mixture into contact with water to generate, in an aqueous phase, an agglutinate of the fine polymer particles (A), the agglutinate containing the organic solvent; a second step of separating and collecting the agglutinate from the aqueous phase, and then mixing the agglutinate with the organic solvent to obtain a first organic solvent dispersion slurry containing the fine polymer particles (A); a third step of mixing the first organic solvent dispersion slurry, a low molecular weight compound (B) that has, in its molecule, at least one polymerizable unsaturated bond and that has a molecular weight of less than 1,000, and a radical scavenger (C) of hindered phenol base to obtain a second organic solvent dispersion slurry containing the fine polymer particles (A), the low molecular weight compound (B), and the radical scavenger (C); and a fourth step of distilling off the organic solvent from the second organic solvent dispersion slurry, the first step, the second step, the third step, and the fourth step being carried out in this order, the fine polymer particles (A) containing a rubber-containing graft copolymer that includes an elastic body and a graft part grafted to the elastic body, the elastic body containing at least one selected from the group consisting of diene-based rubbers, (meth)acrylate-based rubbers, and organosiloxane-based rubbers, and in the third step, the fine polymer particles (A) and the low molecular weight compound (B) being mixed at a blending ratio in which an amount of the fine polymer particles (A) is 1% by weight to 50% by weight and an amount of the low molecular weight compound (B) is 50% by weight to 99% by weight, where 100% by weight represents a total amount of the fine polymer particles (A) and the low molecular weight compound (B).

### EXAMPLES

The following description will discuss one or more embodiments of the present invention in detail with reference to Examples and Comparative Examples. Note that one or more embodiments of the present invention are not limited to these examples. One or more embodiments of the present invention can be altered as appropriate within the scope of the gist disclosed herein. One or more embodiments of the present invention also include, in their technical scope, embodiments achieved by altering the embodiment.

### 1. Production of Aqueous Latex Containing Fine Polymer Particles (A)

### 1. Polymerization of Elastic Body

### Production Example 1-1: Preparation of Aqueous Latex (R-1) Containing Elastic Body Containing Polybutadiene Rubber as Main Component

Into a pressure-resistant polymerization apparatus were introduced 200 parts by weight of deionized water, 0.03 parts by weight of tripotassium phosphate, 0.002 parts by weight of disodium ethylenediaminetetraacetate (EDTA), 0.001 parts by weight of ferrous sulfate heptahydrate, and 1.55 parts by weight of sodium dodecylbenzenesulfonate (SDBS) as an emulsifying agent. Next, while the raw materials thus introduced were stirred, gas in the pressure-resistant polymerization apparatus was replaced with nitrogen, so as to sufficiently remove oxygen from the inside of the pressure-resistant polymerization apparatus. After that, 100 parts by weight of butadiene (Bd) was introduced into the pressure-resistant polymerization apparatus, and the temperature inside the pressure-resistant polymerization apparatus was raised to 45° C. After that, 0.03 parts by weight of paramenthane hydroperoxide (PHP) was introduced into the pressure-resistant polymerization apparatus, and then 0.10 parts by weight of sodium formaldehyde sulfoxylate (SFS) was introduced into the pressure-resistant polymerization apparatus. Polymerization was then started. At the time 15 hours had elapsed from the start of the polymerization, residual monomers not used in the polymerization were removed by devolatilization under reduced pressure, and thereby the polymerization was ended. During the polymerization, PHP, EDTA, and ferrous sulfate heptahydrate were each added to the pressure-resistant polymerization apparatus in discretionarily selected amounts and discretionarily selected points in time. By the polymerization, an aqueous latex (R-1), which contained an elastic body containing polybutadiene rubber as a main component, was obtained. A volume-average particle size of the elastic body contained in the obtained aqueous latex (R-1) was 90 nm.

### Production Example 1-2: Preparation of Aqueous Latex (R-2) Containing Elastic Body Containing Polybutadiene Rubber as Main Component

Into a pressure-resistant polymerization apparatus were introduced 7 parts by weight (in terms of solid content) of the above obtained aqueous latex (R-1), 200 parts by weight of deionized water, 0.03 parts by weight of tripotassium phosphate, 0.002 parts by weight of EDTA, and 0.001 parts by weight of ferrous sulfate heptahydrate. Next, while the raw materials thus introduced were stirred, gas in the pressure-resistant polymerization apparatus was replaced with nitrogen, so as to sufficiently remove oxygen from the inside of the pressure-resistant polymerization apparatus. After that, 93 parts by weight of Bd was introduced into the pressure-resistant polymerization apparatus, and the temperature inside the pressure-resistant polymerization apparatus was raised to 45° C. After that, 0.02 parts by weight of PHP was introduced into the pressure-resistant polymerization apparatus, and then 0.10 parts by weight of SFS was introduced into the pressure-resistant polymerization apparatus. Polymerization was then started. At the time 30 hours had elapsed from the start of the polymerization, residual monomers not used in the polymerization were removed by devolatilization under reduced pressure, and thereby the polymerization was ended. During the polymerization, PHP, EDTA, ferrous sulfate heptahydrate, and SDBS were each added to the pressure-resistant polymerization apparatus in discretionarily selected amounts and discretionarily selected points in time. By the polymerization, an aqueous latex (R-2), which contained an elastic body containing polybutadiene rubber as a main component, was obtained. The volume-average particle size of the elastic body contained in the obtained aqueous latex (R-2) was 195 nm.

### 2. Preparation of Fine Polymer Particles (A) (Formation of Graft Part by Polymerization)

### Production Example 2-1: Preparation of Latex (L-1) Containing Fine Polymer Particles (A)

Into a glass reaction vessel were introduced 250 parts by weight of the aqueous latex (R-2) (including 87 parts by weight of the elastic body containing polybutadiene rubber as a main component) and 50 parts by weight of deionized water. The glass reaction vessel had a thermometer, a stirrer, a reflux condenser, a nitrogen inlet, and a monomer adding device. Gas in the glass reaction vessel was replaced with nitrogen, and the raw materials thus introduced were stirred at 60° C. Next, 0.004 parts by weight of EDTA, 0.001 parts by weight of ferrous sulfate heptahydrate, and 0.20 parts by weight of SFS were added to the glass reaction vessel, and a resultant mixture in the glass reaction vessel was stirred for 10 minutes. After that, a mixture of monomers (hereinafter referred to as “graft monomer”) for forming a graft part (12.1 parts by weight of methyl methacrylate (MMA) and 0.9 parts by weight of butyl acrylate (BA)), and 0.035 parts by weight of t-butyl hydroperoxide (BHP) was added continuously to the glass reaction vessel over 80 minutes. Subsequently, 0.013 parts by weight of BHP was added to the glass reaction vessel, and a resultant mixture in the glass reaction vessel was stirred for another hour so as to complete polymerization. Through the above operations was obtained a latex (L-1) containing the fine polymer particles (A) and the emulsifying agent. Not less than 96% by weight of the monomer component had been polymerized. The volume-average particle size of the fine polymer particles (A) contained in the obtained latex (L-1) was 200 nm. The solid concentration (concentration of the fine polymer particles (A)) in the obtained latex (L-1) was 30% by weight, with respect to 100% by weight of the latex (L-1).

### Production Example 2-2: Preparation of Latex (L-2) Containing Fine Polymer Particles

A latex (L-2) containing fine polymer particles and an emulsifying agent was obtained with a method similar to that of Production Example 2-1, except that 10.6 parts by weight of methyl methacrylate (MMA), 0.9 parts by weight of butyl acrylate (BA), and 1.5 parts by weight of glycidyl methacrylate (GMA) were used as the graft monomers. Not less than 96% by weight of the monomer component had been polymerized. The volume-average particle size of the fine polymer particles contained in the obtained latex (L-2) was 196 nm. The solid concentration (concentration of the fine polymer particles (B)) in the obtained latex (L-2) was 30% by weight, with respect to 100% by weight of the latex (L-2).

### 2. Production of Composition

### Example 1

### (First Step)

As a device, a mixing vessel (capacity: 1 L) equipped with a stirrer was used. As an organic solvent that exhibits partial solubility in water, methyl ethyl ketone (MEK) was used. After setting a temperature inside the mixing vessel to 30° C., 126 parts by weight of MEK was introduced into the mixing vessel. After that, 143 parts by weight of the latex (L-1) of the fine polymer particles (A) was introduced into the mixing vessel while stirring the MEK in the mixing vessel. By uniformly mixing the raw materials thus introduced, a mixture (mixture X) of the aqueous latex containing the fine polymer particles (A) and the organic solvent that exhibits partial solubility in water was obtained. Next, while stirring the mixture X, 200 parts by weight of water (469 parts by weight in total) was introduced into the mixing vessel at a supply rate of 80 parts by weight per minute, and the mixture X was brought into contact with the water. After the feeding of water was ended, stirring was stopped promptly, and a buoyant agglutinate (an agglutinate of the fine polymer particles (A)) was generated in the aqueous phase, and a slurry containing the agglutinate was obtained.

### (Second Step)

Next, the agglutinate was separated and collected from the aqueous phase. Specifically, 350 parts by weight of the aqueous phase was let out from an outlet in a lower part of the mixing vessel so that the agglutinate remained in the mixing vessel, and thus the agglutinate was obtained. To the obtained agglutinate (fine polymer particles (A) dope), 150 parts by weight of MEK was added. The agglutinate and the MEK were mixed to obtain a first organic solvent dispersion slurry containing the fine polymer particles (A). The first organic solvent solution obtained was in an amount of 277 parts by weight (containing 42.9 parts by weight of the fine polymer particles (A)).

### (Third Step)

To 277 parts by weight of the obtained first organic solvent dispersion slurry (containing 42.9 parts by weight of the fine polymer particles (A)), 0.1716 parts by weight of 2,6-di-t-butyl-4-dimethylaminomethylphenol, which was a radical scavenger (C), was introduced, and a resulting mixture was mixed. Next, to the obtained mixture, 64 parts by weight of 2-hydroxypropyl methacrylate (molecular weight: 144), which was a low molecular weight compound (B), was introduced, and a resulting mixture was mixed to obtain a second organic solvent dispersion slurry. In the third step, the fine polymer particles (A) and the low molecular weight compound (B) were mixed at a blending ratio in which an amount of the fine polymer particles (A) was 40% by weight, and an amount of the low molecular weight compound (B) was 60% by weight, where 100% by weight represents a total amount of the fine polymer particles (A) and the low molecular weight compound (B).

### (Fourth Step)

The MEK was distilled off from the obtained second organic solvent dispersion slurry under reduced pressure, and a composition (A-1) was obtained. The composition (A-1) contained the fine polymer particles (A) in an amount of 40% by weight, and the low molecular weight compound (B) in an amount of 60% by weight, where 100% by weight represents a total amount of the fine polymer particles (A) and the low molecular weight compound (B). Moreover, the composition (A-1) contained the radical scavenger (C) in an amount of 0.400 parts by weight, with respect to 100 parts by weight of the fine polymer particles (A).

### Example 2

A composition (A-2) was obtained with a method similar to that of Example 1, except that 2,6-di-t-butyl-p-cresol was used as the radical scavenger (C). The composition (A-2) contained the fine polymer particles (A) in an amount of 40% by weight, and the low molecular weight compound (B) in an amount of 60% by weight, where 100% by weight represents a total amount of the fine polymer particles (A) and the low molecular weight compound (B). Moreover, the composition (A-2) contained the radical scavenger (C) in an amount of 0.400 parts by weight, with respect to 100 parts by weight of the fine polymer particles (A).

### Example 3

A composition (A-3) was obtained with a method similar to that of Example 1, except that pentaerythritol tetrakis[3-(3,5-di-t-butyl-4-hydroxyphenyl)propionate] was used as the radical scavenger (C). The composition (A-3) contained the fine polymer particles (A) in an amount of 40% by weight, and the low molecular weight compound (B) in an amount of 60% by weight, where 100% by weight represents a total amount of the fine polymer particles (A) and the low molecular weight compound (B). Moreover, the composition (A-3) contained the radical scavenger (C) in an amount of 0.400 parts by weight, with respect to 100 parts by weight of the fine polymer particles (A).

### Example 4

A composition (A-4) was obtained with a method similar to that of Example 1, except that 2,4,6-tris(3′,5′-di-t-butyl-4′-hydroxybenzyl)mesitylene was used as the radical scavenger (C). The composition (A-4) contained the fine polymer particles (A) in an amount of 40% by weight, and the low molecular weight compound (B) in an amount of 60% by weight, where 100% by weight represents a total amount of the fine polymer particles (A) and the low molecular weight compound (B). Moreover, the composition (A-4) contained the radical scavenger (C) in an amount of 0.400 parts by weight, with respect to 100 parts by weight of the fine polymer particles (A).

### Example 5

A composition (A-5) was obtained with a method similar to that of Example 1, except that 2,6-di-t-butyl-4-methoxyphenol was used as the radical scavenger (C). The composition (A-5) contained the fine polymer particles (A) in an amount of 40% by weight, and the low molecular weight compound (B) in an amount of 60% by weight, where 100% by weight represents a total amount of the fine polymer particles (A) and the low molecular weight compound (B). Moreover, the composition (A-5) contained the radical scavenger (C) in an amount of 0.400 parts by weight, with respect to 100 parts by weight of the fine polymer particles (A).

### Example 6

A composition (A-6) was obtained with a method similar to that of Example 1, except that acryloyl morpholine (molecular weight: 141) was used as the low molecular weight compound (B) and 0.3432 parts by weight of 2,6-di-t-butyl-4-methoxyphenol was used as the radical scavenger (C). The composition (A-6) contained the fine polymer particles (A) in an amount of 40% by weight, and the low molecular weight compound (B) in an amount of 60% by weight, where 100% by weight represents a total amount of the fine polymer particles (A) and the low molecular weight compound (B). Moreover, the composition (A-6) contained the radical scavenger (C) in an amount of 0.800 parts by weight, with respect to 100 parts by weight of the fine polymer particles (A).

### Comparative Example 1

A composition (A-9) was obtained with a method similar to that of Example 1, except that no radical scavenger was added. The composition (A-9) contained the fine polymer particles (A) in an amount of 40% by weight, and the low molecular weight compound (B) in an amount of 60% by weight, where 100% by weight represents a total amount of the fine polymer particles (A) and the low molecular weight compound (B).

### Comparative Example 2

A composition (A-10) was obtained with a method similar to that of Example 1, except that H-TEMPO (which is not a hindered phenol-based radical scavenger for polymerization) was used as the radical scavenger. The composition (A-10) contained the fine polymer particles (A) in an amount of 40% by weight, and the low molecular weight compound (B) in an amount of 60% by weight, where 100% by weight represents a total amount of the fine polymer particles (A) and the low molecular weight compound (B). Moreover, the composition (A-10) contained the radical scavenger in an amount of 0.400 parts by weight, with respect to 100 parts by weight of the fine polymer particles (A).

### Comparative Example 3

A composition (A-11) was obtained with a method similar to that of Example 1, except that 4-t-butylcatechol (which is not a hindered phenol-based radical scavenger for polymerization) was used as the radical scavenger. The composition (A-11) contained the fine polymer particles (A) in an amount of 40% by weight, and the low molecular weight compound (B) in an amount of 60% by weight, where 100% by weight represents a total amount of the fine polymer particles (A) and the low molecular weight compound (B). Moreover, the composition (A-11) contained the radical scavenger in an amount of 0.400 parts by weight, with respect to 100 parts by weight of the fine polymer particles (A).

### Comparative Example 4

A composition (A-12) was obtained with a method similar to that of Example 1, except that 4-methoxyphenol (which is not a hindered phenol-based radical scavenger for polymerization) was used as the radical scavenger. The composition (A-12) contained the fine polymer particles (A) in an amount of 40% by weight, and the low molecular weight compound (B) in an amount of 60% by weight, where 100% by weight represents a total amount of the fine polymer particles (A) and the low molecular weight compound (B). Moreover, the composition (A-12) contained the radical scavenger in an amount of 0.400 parts by weight, with respect to 100 parts by weight of the fine polymer particles (A).

### 3. Evaluation of Composition

Storage stability of each of the compositions prepared in Examples and Comparative Examples was evaluated based on a difference in viscosity of the composition (rate of change in viscosity) between before and after a storage stability test, the presence or absence of gelation, and the presence or absence of discoloration.

### (Storage Stability Test)

The storage stability test was carried out by placing, inside a sealed glass vessel, each of the compositions prepared in Examples and Comparative Examples and leaving the composition in the sealed glass vessel to stand still in a hot air dryer set at 80° C. for 2 days and 7 days. As Reference Example 1, the low molecular weight compound (B) was similarly subjected to the storage stability test.

### (Measurement of Rate of Change in Viscosity)

The rate of change in viscosity of the composition was calculated by the following expression (1):

Rate of change in viscosity (%)={(viscosity of composition after storage (V₁)−viscosity of composition before storage (V₀))/viscosity of composition before storage (V₀)}×100 (1)

Here, the viscosity (V₀) of the composition before storage is a viscosity of the composition immediately after production in each of Examples and Comparative Examples described above. The viscosity (V₁) of the composition after storage is a viscosity of the composition after 7 days of standing still at 80° C. (after the 7-day storage stability test).

A viscosity of the composition was measured with use of a digital viscometer DV-II+Pro manufactured by BROOKFIELD. The viscosity was measured with use of a spindle CPE-52 in accordance with a viscosity range under conditions in which a measurement temperature was 25° C. and a shear rate (SR) was 10 s⁻¹.

### (Presence or Absence of Gelation)

The presence or absence of gelation in each of the compositions was visually determined immediately after preparation in Examples and Comparison Examples described above, after the composition was left to stand still at 80° C. for 2 days (after the 2-day storage stability test), and after the composition was left to stand still at 80° C. for 7 days (after the 7-day storage stability test).

### (Presence or Absence of Discoloration)

A color of each of the compositions immediately after preparation in Examples and Comparison Examples described above was visually compared to a color of the composition after the composition was left to stand still at 80° C. for 7 days (after the 7-day storage stability test), and thus the presence or absence of discoloration was determined.

### (Evaluation Criteria)

The storage stability of the composition was evaluated by the following criteria, based on the rate of change in viscosity, the presence or absence of gelation, and the presence or absence of discoloration.

Excellent: The rate of change in viscosity of the composition is not more than 30% after the 7-day storage stability test, and no gelation and no discoloration are seen in the composition after the 7-day storage stability test.
Good: The rate of change in viscosity of the composition is not more than 30% after the 7-day storage stability test, and no gelation is seen but discoloration is seen in the composition after the 7-day storage stability test.
Poor: The rate of change in viscosity of the composition is more than 30% after the 7-day storage stability test, or the composition has been gelatinized after the 2-day storage stability test or the 7-day storage stability test.

The results are shown in Table 1.

TABLE 1

| | Rate of change in viscosity | | | | | | |
|---|---|---|---|---|---|---|---|
| | Viscosity before | Viscosity after | Rate of change in | Presence or absence of | | | |
| | storage (V₀) | storage (V₁) | viscosity | gelation | | Presence or absence | |
| | [mPa · s] | [mPa · s] | [%] | 2 days | 7 days | of discoloration | Evaluation |
| Reference | — | | | No gelation | Gelatinized | | Poor |
| Example 1 | | | | | | | |
| Example 1 | 511 | 629 | 23 | No gelation | No gelation | Discolored | Good |
| Example 2 | 531 | 629 | 18 | No gelation | No gelation | No discoloration | Excellent |
| Example 3 | 511 | 609 | 19 | No gelation | No gelation | No discoloration | Excellent |
| Example 4 | 511 | 629 | 23 | No gelation | No gelation | No discoloration | Excellent |
| Example 5 | 511 | 612 | 20 | No gelation | No gelation | No discoloration | Excellent |
| Example 6 | 414 | 512 | 24 | No gelation | No gelation | No discoloration | Excellent |
| Comparative | 520 | | | Gelatinized | Gelatinized | | Poor |
| Example 1 | | | | | | | |
| Comparative | 570 | 806 | 41 | No gelation | No gelation | No discoloration | Poor |
| Example 2 | | | | | | | |
| Comparative | 510 | | | Gelatinized | Gelatinized | | Poor |
| Example 3 | | | | | | | |
| Comparative | 510 | | | Gelatinized | Gelatinized | | Poor |
| Example 4 | | | | | | | |

The compositions of Examples 1 through 6 containing the radical scavenger (C) of hindered phenol base in addition to the fine polymer particles (A) and the low molecular weight compound (B) were not gelatinized after the 7-day storage stability test, exhibited the rate of change in viscosity of not more than 30%, and thus indicated excellent storage stability. Furthermore, the compositions of Examples 2 through 6 containing the radical scavenger (C) that did not have an amino group exhibited no discoloration after the 7-day storage stability test, and had appearances which were the same as those seen immediately after production thereof.

In contrast, Reference Example 1 containing only the low molecular weight compound (B) was not gelatinized after the 2-day storage stability test, but was gelatinized after the 7-day storage stability test. Moreover, the compositions of Comparative Examples 1 through 4 containing no radical scavenger (C) of hindered phenol base were gelatinized after the 2-day storage stability test, or exhibited an increase in viscosity, i.e., had a rate of change in viscosity of more than 30% after the 7-day storage stability test. Thus, the storage stabilities thereof were inferior to those of the compositions of Examples 1 through 4.

One or more embodiments of the present invention make it possible to provide a composition having excellent storage stability. Therefore, the composition in accordance with one or more embodiments of the present invention can be particularly suitably used as materials of adhesive agents, coating materials, binders for reinforcement fibers, composite materials, molding materials for 3D printers, sealants, electronic substrates, and the like.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A composition comprising:
fine polymer particles (A);
a low molecular weight compound (B) having at least one polymerizable unsaturated bond in a molecule of the low molecular weight compound (B), wherein the low molecular weight compound (B) has a molecular weight of less than 1,000; and
a radical scavenger (C) of hindered phenol base,
wherein the fine polymer particles (A) contain a rubber-containing graft copolymer including an elastic body and a graft part grafted to the elastic body,
the elastic body contains at least one selected from the group consisting of diene-based rubbers, (meth)acrylate-based rubbers, and organosiloxane-based rubbers, and
an amount of the fine polymer particles (A) is 25% by weight to 50% by weight and an amount of the low molecular weight compound (B) is 50% by weight to 75% by weight, where 100% by weight represents a total amount of the fine polymer particles (A) and the low molecular weight compound (B).

2. The composition as set forth in claim 1, wherein the molecular weight of the low molecular weight compound (B) is less than 750.

3. The composition as set forth in claim 1, wherein the radical scavenger (C) contains no amino group.

4. The composition as set forth in claim 1, wherein an amount of the radical scavenger (C) contained in the composition is not less than 0.075 parts by weight, with respect to 100 parts by weight of the fine polymer particles (A).

5. The composition as set forth in claim 1, wherein the elastic body comprises:
(i) an elastic core of the elastic body, wherein the elastic core is obtained by polymerizing at least one type of monomer, and the elastic core is selected from the group consisting of diene-based rubbers, (meth)acrylate-based rubbers, and organosiloxane-based rubbers; and
(ii) a surface-crosslinked polymer obtained by polymerizing at least one type of monomer selected from the group consisting of a polyfunctional monomer having at least two polymerizable unsaturated bonds in a molecule of the polyfunctional monomer and a vinyl-based monomer other than the polyfunctional monomer.

6. The composition as set forth in claim 1, wherein the low molecular weight compound (B) is a (meth)acryloyl group-containing compound.

7. The composition as set forth in claim 1, wherein:
the low molecular weight compound (B) contains a compound having at least one functional group X selected from the group consisting of an oxetane group, a hydroxy group, an epoxy group, an amino group, an imide group, a carboxylic acid group, a carboxylic anhydride group, a cyclic ester group, a cyclic amide group, a benzoxazine group, and a cyanate ester group; and
the graft part contains no functional group Y that is reactive with the at least one functional group X.

8. The composition as set forth in claim 1, further comprising a matrix resin (D) having at least two polymerizable unsaturated bonds in a molecule of the matrix resin (D).

9. The composition as set forth in claim 8, wherein the matrix resin (D) is at least one type of curable resin selected from the group consisting of unsaturated polyester, polyester (meth)acrylate, epoxy (meth)acrylate, urethane (meth)acrylate, polyether (meth)acrylate, and acrylated (meth)acrylate.

10. A composition for a 3D printer, comprising the composition recited in claim 1.

11. A method for producing a composition, comprising:
a first step of mixing an aqueous latex containing fine polymer particles (A) with an organic solvent that exhibits partial solubility in water to obtain a resulting mixture, and then bringing the resulting mixture into contact with water to generate an agglutinate of the fine polymer particles (A) in an aqueous phase, wherein the agglutinate contains the organic solvent;
a second step of separating and collecting the agglutinate from the aqueous phase, and then mixing the agglutinate with the organic solvent to obtain a first organic solvent dispersion slurry containing the fine polymer particles (A);
a third step of mixing:
the first organic solvent dispersion slurry,
a low molecular weight compound (B) that has at least one polymerizable unsaturated bond in a molecule of the low molecular weight compound (B) and has a molecular weight of less than 1,000, and
a radical scavenger (C) of hindered phenol base
to obtain a second organic solvent dispersion slurry containing the fine polymer particles (A), the low molecular weight compound (B), and the radical scavenger (C); and
a fourth step of distilling off the organic solvent from the second organic solvent dispersion slurry,
wherein the first step, the second step, the third step, and the fourth step are carried out in an order of the first step, the second step, the third step, and the fourth step,
the fine polymer particles (A) contain a rubber-containing graft copolymer including an elastic body and a graft part grafted to the elastic body,
the elastic body contains at least one selected from the group consisting of diene-based rubbers, (meth)acrylate-based rubbers, and organosiloxane-based rubbers, and
in the third step, the fine polymer particles (A) and the low molecular weight compound (B) is mixed at a blending ratio in which an amount of the fine polymer particles (A) is 1% by weight to 50% by weight and an amount of the low molecular weight compound (B) is 50% by weight to 99% by weight, where 100% by weight represents a total amount of the fine polymer particles (A) and the low molecular weight compound (B).
